(19) United States
(12) Patent Application Publication
(10) Pub. No.: US 2026/0100989 A1
(43) Pub. Date: Apr. 9, 2026

(54) METHODS AND WIRELESS NETWORK FOR INCLUDING VERTICAL APPLICATION LAYER SERVICE AREA IN SEAL SERVER

(71) Applicant: Samsung Electronics Co., Ltd., Suwon-si, Gyeonggi-do (KR)

(72) Inventors: Sapan Pramodkumar SHAH, Bangalore (IN); Basavaraj Jayawant PATTAN, Bangalore (IN); Varadarajan SEENIVASAN, Bangalore (IN); Arunprasath RAMAMOORTHY, Bangalore (IN); Narendranath Durga TANGUDU, Bangalore (IN)

(21) Appl. No.: 19/112,813

(22) PCT Filed: Sep. 21, 2023
(86) PCT No.: PCT/KR2023/014413

§ 371 Date: Mar. 18, 2025

(30) Foreign Application Priority Data
Sep. 21, 2022 (IN) 202241054115
Nov. 5, 2022 (IN) 202241063270
Sep. 6, 2023 (IN) 2022 41054115

(51) Int. Cl. H04L 67/52; H04L 67/50

(52) U.S. Cl. CPC H04L 67/52; H04L 67/535

(57) ABSTRACT

The disclosure relates to a 5G or 6G communication system for supporting a higher data transmission rate. A method performed by a vertical application layer (VAL) server in a wireless communication system is provided. The method comprises transmitting, to a location management server, a user equipment (UE) information request message including a first VAL service area identity (ID) of a first VAL service area and receiving, from the location management server, UE information as a response to the UE information request message. The UE information includes a list of at least one UE whose location is within an application defined proximity range of the first VAL service area corresponding to the first VAL service area ID, and the application defined proximity range includes a range in which the UE information is required.

### TECHNICAL FIELD

Embodiments disclosed herein relate to wireless communication networks (or wireless networks), and more particularly related to methods and wireless networks for including Vertical Application Layer (VAL) Service Area as a location identification attribute in a Service Enabling Architecture Layer (SEAL) server in the wireless networks.

### BACKGROUND ART

5G mobile communication technologies define broad frequency bands such that high transmission rates and new services are possible, and can be implemented not only in “Sub 6 GHZ” bands such as 3.5 GHZ, but also in “Above 6 GHZ” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (cMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Solution to Problem

A method performed by a vertical application layer (VAL) server in a wireless communication system is provided. The method comprises transmitting, to a location management server, a user equipment (UE) information request message including a first VAL service area identity (ID) of a first VAL service area and receiving, from the location management server, UE information as a response to the UE information request message. The UE information includes a list of at least one UE whose location is within an application defined proximity range of the first VAL service area corresponding to the first VAL service area ID, and the application defined proximity range includes a range in which the UE information is required.

A vertical application layer (VAL) server in a wireless communication system is provided. The VAL server comprises a transceiver and a controller coupled with the transceiver and configured to transmit, to a location management server, a user equipment (UE) information request message including a first VAL service area identity (ID) of a first VAL service area, and receive, from the location management server, UE information as a response to the UE information request message. The UE information includes a list of at least one UE whose location is within an application defined proximity range of the first VAL service area corresponding to the first VAL service area ID, and the application defined proximity range includes a range in which the UE information is required.

A method performed by a location management server in a wireless communication system is provided. The method comprises receiving, from a vertical application layer (VAL) server, a user equipment (UE) information request message including a first VAL service area identity (ID) of a first VAL service area; and transmitting, to the location management server, UE information as a response to the UE information request message. The UE information includes a list of at least one UE whose location is within an application defined proximity range of the first VAL service area corresponding to the first VAL service area ID, and the application defined proximity range includes a range in which the UE information is required.

A location management server in a wireless communication system is provided. The location management server comprises a transceiver and a controller coupled with the transceiver and configured to receive, from a vertical application layer (VAL) server, a user equipment (UE) information request message including a first VAL service area identity (ID) of a first VAL service area, and transmit, to the location management server, UE information as a response to the UE information request message. The UE information includes a list of at least one UE whose location is within an application defined proximity range of the first VAL service area corresponding to the first VAL service area ID, and the application defined proximity range includes a range in which the UE information is required.

### BRIEF DESCRIPTION OF DRAWINGS

The proposed system and method are illustrated in the accompanying drawings, throughout which like reference letters indicate corresponding parts in the various figures. The embodiments herein will be better understood from the following description with reference to the drawings, in which:

FIG. 1 illustrates a sequence diagram in which a SEAL server (e.g., SEAL CM server) pulls an application server profile and configuration from a VAL server that includes a VAL service identification, a list of subscribed VAL UEs for its service, a VAL service area identification and details of the area like name, geographical area, according to embodiments as disclosed herein;

FIG. 2 illustrates a sequence diagram in which the VAL server requests a SEAL location management (LM) Server with the VAL service area identification to provide the location information of UEs in a particular area defined by the VAL service Arca in its response the SEAL LM Server, according to an embodiment;

FIG. 3 illustrates a sequence diagram in which the VAL server requests the SEAL LM server with the VAL service area identification to provide location trigger notifications when the UE leaves/enters an area as defined by a VAL service area in its response, according to embodiments as disclosed herein;

FIG. 4 illustrates a sequence diagram in which the VAL server requests a SEAL group management (GM) server to group all the UEs in the area defined by the VAL Service Area, according to embodiments as disclosed herein;

FIG. 5 illustrates a sequence diagram in which the SEAL GM server notifies the VAL server on updating of the newer UEs/moving out of older UEs from the group in accordance with a UE location from the SEAL LM server, according to embodiments as disclosed herein;

FIG. 6 illustrates a sequence diagram in which the VAL server requests the SEAL servers (e.g., SEAL NRM) to treat all UEs in a service area as one group identified by the VAL Service Area Identification and monitor/update as one group, according to embodiments as disclosed herein;

FIG. 7 illustrates a sequence diagram in which the SEAL servers (e.g., SEAL NRM) receive/update notifications/configurations to all the members of the group identified by the VAL Service Area ID, according to embodiments as disclosed herein;

FIG. 8 is an illustration of a functional model for avatar management system, according to embodiments herein;

FIG. 9 illustrates a sequence diagram in which operations of an avatar management system is explained, according to embodiments herein;

FIG. 10 shows various hardware components of the VAL server, according to the embodiments as disclosed herein;

FIG. 11 shows various hardware components of the SEAL server, according to the embodiments as disclosed herein;

FIG. 12 shows various hardware components of a client apparatus, according to the embodiments as disclosed herein;

FIG. 13 is a flow chart illustrating a method, implemented by the VAL server, for managing mapping of a VAL service area ID and a geographical area in a wireless network, according to the embodiments as disclosed herein;

FIG. 14 is a flow chart illustrating a method, implemented by the SEAL server, for managing mapping of the VAL service area ID and the geographical area in the wireless network, according to the embodiments as disclosed herein;

FIG. 15 is a flow chart illustrating a method, implemented by the SEAL server, for managing a digital representation in a wireless network, according to the embodiments as disclosed herein;

FIG. 16 is a flow chart illustrating a method, implemented by the client apparatus, for managing a digital representation in a wireless network, according to the embodiments as disclosed herein;

FIG. 17 illustrates a structure of a UE according to an embodiment of the disclosure; and

FIG. 18 is a block diagram showing an internal structure of a network entity, according to an embodiment of the present disclosure.

### BEST MODE FOR CARRYING OUT THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

The embodiments herein achieve methods and systems for including a Vertical Application Layer Service Area as a location identification attribute in a SEAL server. The method can be used for managing mapping of a VAL service area ID and a geographical area in a wireless network. The method includes configuring, by a VAL server, a VAL service area ID based on a VAL service area. Further, the method includes registering, by the VAL server, a mapping of the at least one VAL service area ID with a geographical area to a SEAL server. The method can be used to enable seamless automatic efficient service delivery for multiple VAL SPs to the consumers using the SEAL server.

The 3GPP has introduced SEAL as a platform or the server to enable multiple VALs use common features like Group Management and network information and management like Location Management and Network Resource Management.

In general, interpretation of Location means different to different entities depending upon the context. For example, for a consumer, location is invariably civic address. For a network, it is one of latitude/longitude, Tracking Area/Routing Arca (TA/RA), eNODEB ID, and Cell ID. For a Vertical Application Layer (VAL), location can refer to the jurisdictional area of service. V2X Service Provider has regions where it deploys its platform for its edge control, Mission Critical Push-to-Talk (MCPTX) Service first responders have area of responsibility mostly as much near to the location of the caller user, Government vertical services has districts/municipals/prefectures/counties/wards for local administration, Water supply companies have wards, Electricity companies have substations, Health centers have wards, countries to maintain law and order have police station limits, Logistics Service Provider has distribution area, Retail Service Provider has retail area, Banking have branches, and so on. Since every Vertical Application Layer (VAL) has this concept, embodiments herein incorporate the seamless integration of these areas with Network area (cell, TA) in SEAL so that each VAL can work with SEAL in terms of their own service areas instead of asking every VAL user to use geographical co-ordinates. The VAL Administrator during VAL Service registration or on-boarding shall give SEAL the service area-geographical co-ordinates mapping one time and subsequently any of the SEAL Service user-Location Management (LM)/Group Management (GM)/Network Resource Management (NRM) etc. can interact with SEAL just with its Service Arca.

With this mechanism, the VAL service area can be defined once, then the Service Arca information can be used at multiple application programing interface (APIs). When there is change/update in the VAL service Area, then the VAL server can just update the VAL service area at the SEAL server and need not update its subscription to various APIs where location information is significant.

In an embodiment, the VAL Server (100) instead of tracking its UEs in an interested service area by providing explicitly the geographical co-ordinates of such an area in its requests to the SEAL server each time, the location management (LM) can simply refer to a Service Area ID and the SEAL LM server can map the same from its database and provide the requested UEs to the VAL server.

In an embodiment, the VAL server can track UEs in a particular Service Arca by simply providing the ID to the SEAL LM and gets a trigger whenever the UE has moved out or moved in. In another embodiment, the VAL server would have had to define and provide this geographical area in each of its requests to the SEAL LM. The UE can be, for example, but not limited to a laptop, a smart phone, a desktop computer, a notebook, a Device-to-Device (D2D) device, a vehicle to everything (V2X) device, a foldable phone, a smart TV, a tablet, an immersive device, and an internet of things (IoT) device.

In an embodiment, the VAL server can define a group of UEs belonging to a particular Service Arca by just providing VAL Service Area ID to SEAL GM and address dynamically all of the UEs currently in the Service Area. In another embodiment, the VAL server had to define the UE group by explicitly mentioning geographical area co-ordinates. It is also difficult to implement changes in the VAL Service Area when its service expands as all of the groups created with the old geographical area will become void and the procedures will need to be recreated with the newer co-ordinates. Changes in VAL Service Area will be automatic herein, when the VAL server notified the same in the VAL AS configurations to the SEAL server and the SEAL server internally re-creates the group in accordance with the changes in the Service Arca.

In an embodiment, the VAL server (100) can create a group of UEs belonging to a particular Service Area by just providing VAL Service ID and refer to the group ID when it registers to Network Services like SEAL Network Resource Monitoring (NRM). The SEAL NRM will monitor dynamically all the UE events including the analytics events from the Network and inform VAL about the same for VAL to be aware of and to take appropriate actions.

In an embodiment, the generic service area concept can function in the same purpose to all VALs, what the existing eMBMS Service Area and quality of service (QoS) Area in technical specification do to the eMBMS and QoS services. Here, the VAL Service Area is present in the Location Report Configuration, location reports, trigger for area when the UE moves out and in of the VAL Service Area etc.

In an embodiment, the VAL client is configured with the VAL service Area ID and its geographical area, and the VAL client/SEAL client can include this information when interacting with the SEAL server/VAL server. In an embodiment, the SEAL server (200) can derive the corresponding VAL service Area ID on receiving the geographical area from the SEAL client/VAL client.

Embodiments herein disclose a location attribute called VAL Service Area, which refers to the geographical area served by a particular VAL, and making it a part of location attribute which can be associated with the UE along with the existing location attributes like Latitude/Longitude, Tracking Area/Routing Area, civic address etc. This will enable seamless automatic efficient service delivery for multiple VAL SPs to the consumers using SEAL.

Embodiments herein disclose a new location attribute from VAL perspective which can be identified for a consumer device (e.g., UE or the like) by all the parties involved like VAL, the network etc. through a VAL Service ID. This is along with other existing location information like Civic address (from user perspective), RA/TA, eNODEB ID, Cell ID, longitude/latitude (from the network perspective). This can be on the lines of E-UTRAN cell global identifier (ECGI) Service Area, multimedia broadcast and multicast services (MBMS) Service Area concept which is already introduced on specific case basis.

Embodiments herein disclose new procedures where the VAL server can request a SEAL LM server by providing VAL Service ID as a way to identify a defined geographical area instead of populating each time the co-ordinates to get the location of the UE within a service area or to track UEs in and out of a service area.

Embodiments herein disclose new procedures where the VAL server can request the SEAL GM server to group all UEs dynamically by providing a VAL Service Arca ID instead of providing geographical area co-ordinates.

Embodiments herein disclose a method in which the VAL server (100) utilizes the group created with the SEAL GM server and dynamically manages the Network and VAL services for all the UEs located in a particular VAL service area.

Embodiments herein disclose a method for the SEAL server to obtain the network service from Network Exposure Function (NEF) based on VAL Service Area received from the VAL server.

Embodiments herein disclose procedures for the VAL server to intimate the SEAL on the geographical co-ordinates of the service areas, which the SEAL utilizes to request the Network or other VALs in an opaque manner and serve the requesting VAL server efficiently with respect to its service area scope.

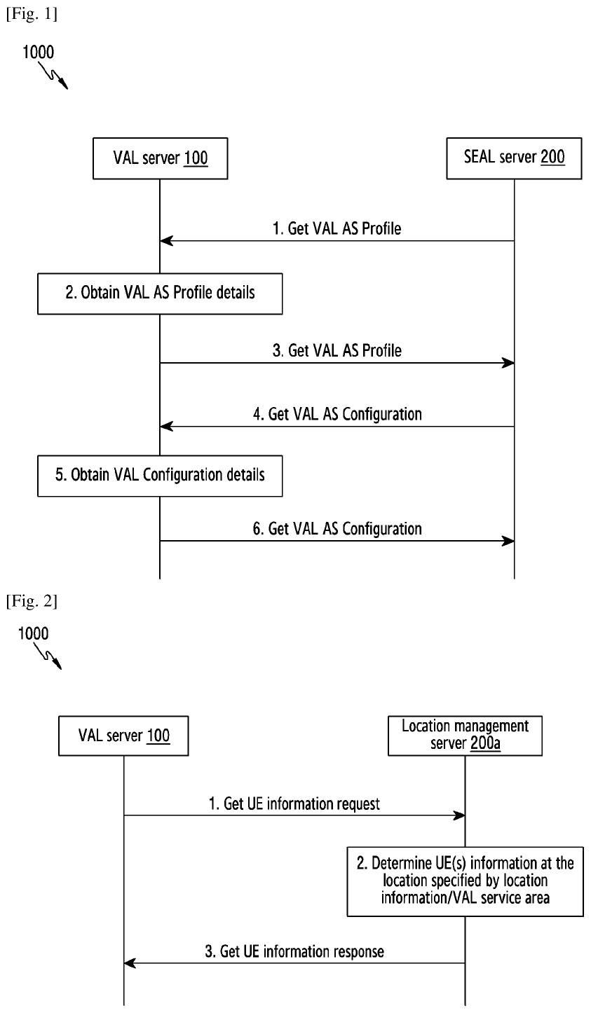

Referring now to the drawings, and more particularly to FIGS. 1 through 16, where similar reference characters denote corresponding features consistently throughout the figures, there are shown at least one embodiment.

Fifth Generation (5G) cellular networks provide enhanced communication services to consumers in the form of increased speed and reliability. In addition to the same, newer types of services are provided to business consumers-Vertical Application Layer Service Providers (VAL SP). They include services like Augmented Reality/Virtual Reality (AR/VR), Vehicle to Anything (V2X), Government Utilities using Internet of Things platforms like Smart Electricity, Smart Utilities, Smart Transport and Smart City, Remote Health services, Uncrewed Arial Vehicle (UAV), Factories of the Future (FF), and so on. This introduces a new challenge in coordinating between the wireless network and the various VAL, which are hitherto done using standalone manual methods.

In release to a metaverse is considered as a digital world that is replica of a real world or can be considered as a three dimensional (3D) model of internet. Everyone or every entity would have a digital 3D avatars and a user can enter the digital world using the digital 3D avatar instead of searching from outside internet. Generally it refers to shared and immersive lifelike digital environments (i.e. virtual universes) that people can move between using Extended Reality (XR) devices. Virtual venues can be created for events or shops or mall or entertainment park that enables companies to run business online. Currently, there are already many digital environments (i.e. virtual universes), which typically run in silo and are not interconnected. Each Metaverse application needs the digital 3D avatar for the user to interact with the application. For each application, the user may be required to create, modify, delete the avatars. Further, each avatar (regardless of application) will have some common properties—like shape, color, virtual position, speed, direction of movement, etc. Depending on the Metaverse application where the customer or the user wants to connect to, he/she can choose his/her avatar and the related information when needed.

It is desired to address the above mentioned disadvantages or other short comings or at least provide a useful alternative.

The principal object of the embodiments herein is to disclose methods and systems (or wireless networks) for including a VAL service area as a location identification attribute in a service enabling architecture layer (SEAL) server in a 3^{rd} Generation Partnership Project (3GPP) network, where the location attribute (hereinafter referred to as VAL service area), which refers to the geographical area served by a particular VAL server, and making the attribute a part of location attribute which can be associated with a User Equipment (UE) along with existing location attributes like Latitude/Longitude, Tracking Area/Routing Area, civic address etc., hereby enabling seamless automatic efficient service delivery for multiple VAL SPs to the consumers using SEAL.

Another object of the embodiments herein is to disclose about usage of a VAL service area ID while obtaining a list of UEs at a specific location.

Another object of the embodiments herein is to disclose about usage of the VAL service area ID as a criteria for creating a group based on the location.

Another object of the embodiments herein is to disclose about usage of the VAL service area ID as criteria in a location area monitoring subscription procedure, which is used to monitor UEs moving in or out of a particular area.

Another object of the embodiments herein is to enable an application enabler service to manage avatars and its associated information for a metaverse application in the wireless network.

Another object of the embodiments herein is to specify an interface for Avatar Management Service (AMS) including a first entity (i.e., client side function) and a second entity (server side function).

Another object of the embodiments herein is to disclose about the user can move between metaverse applications using the same avatar seamlessly and taking into account the constraints of the universe visited.

Accordingly, the embodiments herein provide methods for managing mapping of a VAL service area identifier (ID) and a geographical area in a wireless network. The method includes configuring, by a VAL server, at least one VAL service area ID based on a VAL service area. Further, the method includes registering, by the VAL server, a mapping of the at least one VAL service area ID with a geographical area to a SEAL server.

In an embodiment, the method further includes performing, by the VAL server, at least one of: creating mapping of the VAL service area ID and the geographical area, modifying mapping of the VAL service area ID and the geographical area, updating mapping of the VAL service area ID and the geographical area, and deleting mapping of the VAL service area ID and the geographical area.

In an embodiment, the mapping of the VAL service area ID and the geographical area associated with the VAL service area ID is registered through a configuration information.

In an embodiment, the SEAL server propagates the mapping of the VAL service area ID and the associated geographical area to all other SEAL servers in a SEAL domain.

In an embodiment, the method further includes sending, by the VAL server, a get UE information request to the SEAL server. The get UE information request includes a location information, the VAL service area ID and an application defined proximity range. The SEAL server determines that location area associated with a UE is within the application defined proximity range of the location information. Further, the method includes receiving, by the VAL server, a get UE information response from the SEAL server based on the get UE information request. The get UE information response includes a list of UEs and a location information corresponding to the list of UEs residing in the geographical area represented by the VAL service area ID.

In an embodiment, the method further includes sending, by the VAL server, a location area monitoring subscription request to the SEAL server to subscribe to a list of UEs moving in or moving out of a location area. The location area monitoring subscription request includes at least one of an identity of at least one of the VAL server, a VAL UE, and the SEAL server, a location information criteria having at least one of a geographic location information, the VAL service area ID denoting a geographical location information, and a reference UE along with an application defined proximity range from a reference UE, an time interval between consecutive reports, an immediate report indicator and at least one triggering event. Further, the method includes receiving, by the VAL server, a location area monitoring subscription response from the SEAL server based on the location area monitoring subscription request in response to the SEAL server determines that the VAL server is authorized to initiate the location area monitoring subscription request.

In an embodiment, the method further includes sending, by the VAL server, a location based group creation request including the VAL service ID to a first SEAL server. Further, the method includes receiving, by the VAL server, a location based group creation response message from the first SEAL server based on the location based group creation request.

In an embodiment, the location based group creation response message is created by requesting, by the first SEAL server, to obtain at least one UE corresponding to location information to a second SEAL server, receiving, by the first SEAL server, the list of UEs within the requested location from the second SEAL server, and creating and storing, by the first SEAL server, information of a location-based group during a group creation. The second SEAL server generates a list of UEs within the requested location and shares with the list of UEs within the requested location to the first SEAL server.

In an embodiment, the first SEAL server can be a group management server and the second SEAL server can be a location management server.

Accordingly, the embodiments herein provide methods for managing mapping of a VAL service area ID and a geographical area in a wireless network. The method includes receiving, by a SEAL server, mapping of at least one VAL service area ID with a geographical area from a VAL server. Further, the method includes storing, by the SEAL server, mapping of the at least one VAL service area ID with the geographical area.

In an embodiment, the method further includes receiving, by the SEAL server, a get UE information request from a VAL server. The get UE information request includes the VAL service area ID and an application defined proximity range. Further, the method includes determining, by the SEAL server, that location area associated with the VAL service area ID. Further, the method includes sending, by the SEAL server, a get UE information response to the VAL server based on the get UE information request. The get UE information response includes a list of UEs residing in the geographical area represented by the VAL service area ID and a location information corresponding to the list of UEs.

In an embodiment, the method further includes receiving, by the SEAL server, a location area monitoring subscription request from the VAL server to subscribe to a list of UEs moving in or moving out of a specific location area. The location area monitoring subscription request includes at least one of an identify of at least one of the VAL server, a VAL UE, and the SEAL server, a location information criteria including at least one of a geographic location information, the VAL service area ID denoting a geographical location information, and a reference UE along with an application defined proximity range from a reference UE, an time interval between consecutive reports, an immediate report indicator and at least one triggering event. Further, the method includes determining, by the SEAL server, that the VAL server is authorized to initiate the location area monitoring subscription request. Further, the method includes sending, by the SEAL server, a location area monitoring subscription response to the VAL server based on the location area monitoring subscription request.

In an embodiment, the method further includes receiving, by a first SEAL server, a location based group creation request including a VAL service ID from a VAL server. Further, the method includes sending, by the first SEAL server, a location based group creation response message to the VAL server based on the location based group creation request.

Accordingly, the embodiments herein provide methods for managing a digital representation in a wireless network. The method includes sending, by a client apparatus, a request message to perform at least one operation associated with the digital representation along with properties and related information of the digital representation to a SEAL server. Further, the method includes receiving, by the client apparatus, a response message in response to performing the operation associated with the digital representation from the SEAL server based on the request message upon authorizing the request message at the SEAL server.

In an embodiment, the at least one operation includes a create operation, a get operation, a modification operation and a delete operation. The digital representation includes an avatar or alter egos or digital assets or digital wallet or any other suitable name for the digital representation.

In an embodiment, the properties or the related information of the digital representation includes at least one of an avatar identity, user list, current status, shape, size, color, virtual position, access right, authentication information, a security token, allowed application list, allowed location, wallet list, a predictive model, life time, an input technique, expiry time, speed, location history, and an application history.

In an embodiment, the avatar ID is used to uniquely identify the avatar or alter egos or digital representation, wherein the user list includes a list of one or more user's identity who are allowed to use the Avatar, wherein the current status indicates whether the avatar is currently in use or not, wherein the allowed application list specifies the list of the application identifiers for which the Avatar is used, wherein the allowed location specifies the location range or the area of the user whether the Avatar can be used, wherein one or more predictive model specifies the model used to train the Avatar, wherein the life time indicates the time since the Avatar is created and registered, wherein the expiry time indicates the time till when the Avatar can be used by the user, wherein the wallet list specifies the identity associated with user's finance source (like bank or credit card) which allows user to purchase items in the metaverse using the avatar, wherein the access rights, authentication information and security tokens are used to provide secure access of Avatar and its related information to the consumer.

In an embodiment, the request message includes at least one of an digital representation ID, at least one operation and parameters. The parameters include at least one of an avatar identity, user list, current status, shape, size, color, virtual position, access right, authentication information, a security token, allowed application list, allowed location, wallet list, a predictive model, life time, an input technique, expiry time, speed, location history, and an application history.

In an embodiment, the client apparatus is communicated with the SEAL server over an interface-1, where the interface-1 supports a unicast delivery mode and a multicast delivery mode.

Accordingly, the embodiments herein provide methods for managing a digital representation in a wireless network. The method includes receiving, by a SEAL server, a request message to perform at least one operation associated with the digital representation along with properties and related information of digital representation from a client apparatus. Further, the method includes authorizing, by the SEAL server, the request message at the SEAL server. Further, the method includes sending, by the SEAL server, a response message in response to performing the operation associated with the digital representation to the client apparatus based on the request message.

Accordingly, the embodiments herein provide a wireless network including a first client apparatus, and a first SEAL server. The first SEAL server receives a request message to perform at least one operation associated with the digital representation along with properties and related information of digital representation from the first client apparatus. Further, the first SEAL server authorizes the request message at the first SEAL server. Further, the first SEAL server sends a response message in response to performing the operation associated with the digital representation to the first client apparatus based on the request message.

In an embodiment, the wireless network includes a second client apparatus, a second server, and a 3^{rd} Generation Partnership Project (3GPP) network. The first client apparatus is communicated with the first SEAL server over an interface-1, where the interface-1 supports a unicast delivery mode and a multicast delivery mode. The second client apparatus (e.g., VAL client) is communicated with the second server (e.g., VAL server) over an interface-4. The first client apparatus is communicated with the second client apparatus over an interface-5. The first SEAL server is communicated with the second server over an interface-2. The 3GPP network is communicated with the first SEAL server over an interface-3.

In an embodiment, the first client apparatus provides a service enabler layer support function for managing the digital representation along with properties and related information of digital representation to the second client apparatus over an interface-5. The first SEAL server for managing the digital representation to an application function.

Accordingly, the embodiments herein provide a VAL server including a VAL service area controller coupled with a processor and a memory. The VAL service area controller configures at least one VAL service area ID based on a VAL service area. Further, the VAL service area controller registers a mapping of the at least one VAL service area ID with a geographical area to a SEAL server.

Accordingly, the embodiments herein provide a SEAL server including a VAL service area controller coupled with a processor and a memory. The VAL service area controller receives a mapping of the at least one VAL service area ID with a geographical area from a VAL server. Further, the VAL service area controller stores the mapping of the at least one VAL service area ID with the geographical area.

Accordingly, the embodiments herein provide a client apparatus including a digital representation controller coupled with a processor and a memory. The digital representation controller is configured to send a request message to perform at least one operation associated with the digital representation along with properties and related information of digital representation to a SEAL server. Further, the digital representation controller is configured to receive a response message in response to performing the operation associated with the digital representation from the SEAL server based on the request message upon authorizing the request message at the SEAL server.

Accordingly, the embodiments herein provide a SEAL server including a digital representation controller coupled with a processor and a memory. The digital representation controller is configured to receive a request message to perform at least one operation associated with the digital representation along with properties and related information of digital representation from a client apparatus. Further, the digital representation controller is configured to authorize the request message at the SEAL server. Further, the digital representation controller is configured to send a response message in response to performing the operation associated with the digital representation to the client apparatus based on the request message.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

FIG. 1 illustrates a sequence diagram in which a SEAL server (e.g., SEAL CM server) (200) pulls an application server profile and configuration from the VAL server (100) that includes a VAL service identification, a list of subscribed VAL UEs for its service, a VAL service area identification and details of the area like name, geographical area, according to embodiments as disclosed herein.

The VAL server (100) has an Identification, details about itself, the type of services offered in the form of VAL Application Server (AS) Profile. The VAL server (100) in its configurations data has the list of UEs that are subscribed to its service along with its jurisdictional area in the form of VAL Service Area Identification-Geographical area pair. Whenever VAL AS decides to use SEAL and after its authentication to SEAL, the SEAL CM can pull this data from the VAL server (100) and get its details updated periodically through notifications.

The pre-conditions are as follows:
a) The VAL user has performed user authentication in an identity management server.
b) The VAL server (100) has secure access to the SEAL server (200).
c) The VAL server (100) already has VAL AS Profile details, UE details that are subscribed to its service along with VAL Service Area details mapping the ID with a geographical area.
d) The CM Server has access to the VAL AS Profile and Configurations.

In step 1, the SEAL configuration management (CM) server (200) sends a get VAL AS profile request message to the VAL server (100), which includes the VAL Service ID. Alternatively, the VAL AS can send the same during a registration process. In step 2, the VAL server (100) obtains the VAL AS profile information. In step 3, the server (100) sends get a VAL AS profile response message to the configuration management server (200). In step 4, the configuration management server (200) sends a get VAL AS configuration request to the VAL server (100) for obtaining VAL AS configuration data. In step 5, the VAL server (100) collects the configuration information like VAL AS configuration data, which includes the set of all VAL UEs, which are subscribed to the VAL service, the list containing mapping of VAL service area with geographical area (denoted by co-ordinates). In step 6, the VAL server (100) sends a VAL AS configuration response to the CM server (200). There are other VAL AS configurations like Administrative Status, Operational Status, Communication Status, Transmission rate, Buffer length, Codec scheme which are in VAL scope but yet needed by SEAL and NW as it impacts the VAL Quality Of Experience (QoE), and NW QoS (Quality Of Service) (which has been described in the SEAL ASM).

Table 1.1 describes the information flow get VAL AS profile request from the configuration sever to the VAL server (100).

TABLE 1.1

| Information element | Status | Description |
|---|---|---|
| Identity | M | The identity of the VAL Service |
| | | offered by VAL AS |

Table 1.2 describes the information flow get VAL AS profile response from the VAL server (100) to the configuration server.

TABLE 1.2

| Information element | Status | Description |
|---|---|---|
| VAL service ID | O | Identity of the VAL service for which |
| | | the profile is requested. |
| VAL Service Name | O | Name of the VAL Service |
| VAL Service Details | O | Annotations, Details of the VAL |
| | | Service |
| VAL Service Type | O | Service type like V2X, FF, UAV, IOT |
| | | etc. |
| Result | M | Indicates the success or failure for the |
| | | operation |

NOTE:
VAL AS Profiles contain VAL Service ID, VAL name, VAL details like address and VAL Service Type. If the Result information element indicates failure then the value of VAL AS profile data information element has no meaning.

Table 1.3 describes the information flow get VAL AS configuration request from the configuration sever to the VAL server (100).

TABLE 1.3

| Information element | Status | Description |
|---|---|---|
| Identity | M | The identity of the VAL Service |
| | | offered by VAL AS |

Table 1.4 describes the information flow get VAL AS configuration response from the VAL server (100) to the configuration server.

TABLE 1.4

| Information element | Status | Description |
|---|---|---|
| VAL Service ID | Optional | Identity of the VAL service for which |
| | (O) | the profile is requested. |
| VAL Parameter List | O | List of VAL Parameters |
| >Buffer Length | O | Buffer length of the VAL Service for |
| | | transmission |
| >Transmission Rate | O | Rate at which the VAL Service |
| | | transfers the information |
| >Administrative | O | The current VAL Service status as |
| Service Status | | managed by VAL Management |
| | | System. It can be enable, disable |
| >Operational | O | The current operational status of |
| Service Status | | VAL Service. It can be In-Service, |
| | | Out-Of-Service |
| >Communication | O | The VAL service reachability status |
| Service Status | | |
| List of VAL UEs | Mandatory | List of UEs subscribed to VAL |
| | (M) | Service |
| List of VAL Service | O | List of VAL Service Areas identified |
| Areas | | distinctly through geographical area |
| [symbol] VAL Service | O | VAL Service Identity |
| Area ID | | |
| [symbol] Geographical | O | Identifies the geographical information |
| area | | of the user(s) as defined in |
| | | 3GPP TS 29.572 |
| Result | M | Indicates the success or failure for the |
| | | operation |

NOTE:
VAL AS configurations contain VAL Service ID, VAL Parameters like buffer length, transmission rate etc., list of VAL UEs subscribed to its service, list of VAL Service Area ID along with its geographical area mapping. If the Result information element indicates failure then the value of VAL AS profile data information element has no meaning.

Embodiments herein capture who are all the consumers of VAL service Area ID, how they dereference the VAL service Area ID etc., and how the VAL service Area ID is distributed. The VAL Service Area ID is defined by the VAL server administrator and utilized by other VAL server users utilizing SEAL LM, GM, NRM etc. It is also utilized by the VAL UE at the time of its subscription to the VAL Service. The VAL server (100) at the time of registration and initial configuration sends the information related to the VAL Service ID and its geographical mapping to the SEAL server (200) which stores it as a configuration information to be referred by any of its service like LM, GM, NRM etc. Any change to the Service Area ID definition that includes expansion or contraction of area, removal and addition of area is through notification changes from VAL server (100) to SEAL as a onetime message which dynamically and seamlessly used across other subsystems and VAL Users.

FIG. 2 illustrates a sequence diagram in which the VAL server (100) requests the SEAL location management (LM) server (200a) with the VAL service area identification to provide the location information of UEs in a particular area defined by the VAL service Area in its response from the SEAL LM server (200a), according to an embodiment. The pre-conditions are as follows:
a) The VAL server (100) has a jurisdiction over a geographical area for which the location management server (200a) is configured to operate.
b) The UE(s) in the geographical area have provided its location information to the location management server (200a).

In step 1, the VAL server (100) sends Get UE information request to the location management server (200a). The request contains (or, include) a location information, VAL Service Area Identification and/or application defined proximity range. In step 2, the location management server (200a) determines the UE(s) whose location are within the application defined proximity range of the location information/VAL Service Area Identification, as provided in step 1. In step 3, the location management server (200a) sends UE information response to the VAL server (100) with a list of UE(s) and its corresponding location information/VAL Service Area Identification as determined in step 1.

Table 2.1 describes the information flow for the VAL server (100) to get UE(s) information at the LM server.

TABLE 2.1

| Information element | Status | Description |
|---|---|---|
| Location information | O | Location information around which |
| | | the UE(s) information is requested. |
| VAL Service Area ID | O | VAL Service Area Identification |
| Application defined | M | Description of the range information |
| proximity range | | over which the UE(s) information is |
| information | | required. |

Table 2.2 describes the information flow for a LM server to respond with UE(s) information to the VAL server (100).

TABLE 2.2

| Information | | |
|---|---|---|
| element | Status | Description |
| Result | M | Result from the VAE server in |
| | | response to subscription request |
| | | indicating success or failure |
| List of UEs | O | The information of the UEs which were |
| information | | detected in the application defined |
| (see NOTE) | | proximity range. The list can be empty. |
| >UE ID | M | The identifier of UE |
| >Location | CM | Location information of UE within the |
| information | | application defined proximity range |
| >VAL Service | CM | VAL Service ID defining the Location |
| Area ID | | information of UE within the |
| | | application defined proximity range |

NOTE:
This IE shall be included when the Result indicates success.

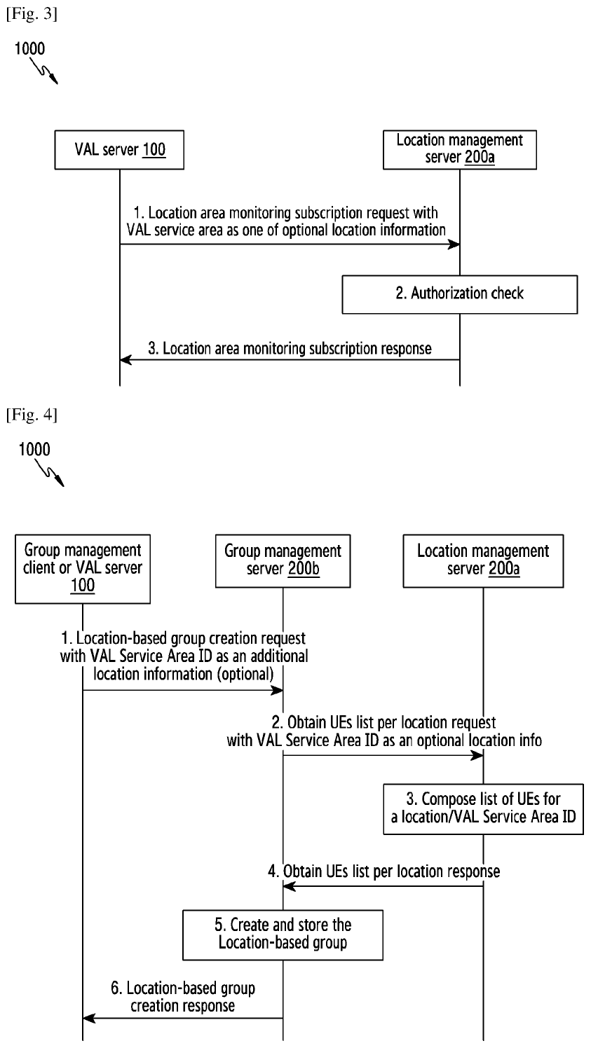

FIG. 3 illustrates a sequence diagram in which the VAL server (100) requests the SEAL LM server (200a) with the VAL service area identification to provide location report when the UE leaves/enters an area as defined by the VAL service area in its response, according to an embodiment. The same procedure can be applied for location management client and other SEAL servers (200) that would like to subscribe to the list of UEs moving in or moving out of the specific location area. The subscribe request can be for a reference UE for which the subscriber is authorized to monitor the location information.

In step 1, the VAL server (100) sends (or, transmit) a location area monitoring subscription request to the location management server (200a) to subscribe to the list of UEs moving in or moving out of the specific location area. In the request message (e.g., the location area monitoring subscription request), the VAL server (100) includes at least a part of the information as specified in Table 3.1. The location information criteria may include the geographic location information where the UEs moving in or moving out to be monitored, or a VAL service area location identified by VAL Service Area ID or it may include reference UE information where in the UEs moving in or moving out of given application defined proximity range from the reference UE (target UE) to be monitored. The reference UE information may include VAL UE ID, GPSI. In step 2, the location management server (200a) shall (or, may) check if the VAL server (100) is authorized to initiate the location area monitoring subscription request. In step 3, the location management server (200a) replies with a location area monitoring subscription response indicating the subscription status. In the response message (e.g., location area monitoring subscription response), the location management server (200a) includes at least a part of the information as specified in Table 3.2.

Table 3.1 describes the information flow from the VAL server (100) to the location management server (200a) for location area monitoring subscription request.

TABLE 3.1

| Information | | |
|---|---|---|
| element | Status | Description |
| Identity | M | Identity of the requesting VAL server, |
| | | VAL UE or SEAL Server |
| Location | M | Location information to be monitored. |
| Information | | It includes the geographic location |
| criteria | | information or a VAL Service Area ID |
| | | denoting a particular geographical |
| | | location information or a reference UE |
| | | along with the application defined |
| | | proximity range from the reference UE. |
| Time between | O | It indicates the interval time between |
| consecutive | | consecutive reports |
| reports | | |
| Immediate | O | Indicates whether an immediate |
| Report | | |
| Indicator | | location report is required |
| Triggering | O | Identifies when the server will send the |
| events | | notification (e.g. distance travelled) |

Table 3.2 describes the information flow from the location management server (200a) to the VAL server (100) for location area monitoring subscription response.

TABLE 3.2

| Information | | |
|---|---|---|
| element | Status | Description |
| Subscription | M | It indicates the subscription result |
| status | | |
| Subscription | O | If subscription is successful, identifies |
| identity | (see | the subscription |
| | NOTE) | |

NOTE:
This IE shall be present if subscription status is set to success.

Table 3.3 describes the information flow from the location management server (200a) to the VAL server (100).

TABLE 3.3

| Information element | Status | Description |
|---|---|---|
| Subscription identity | M | Identity of the subscription |
| UEs currently present | O | List of the identities of all VAL UEs |
| (NOTE) | | who are currently present in the given |
| | | location area |
| UEs moved in/out | O | List of UEs either moved in to the |
| (NOTE) | | location area or moved out of the |
| | | location area |
| >> UEs moved in | O | List of the identities of the VAL UEs |
| | | who moved in to the given location |
| | | area since previous notification. |
| >> UEs moved out | O | List of the identities of the VAL UEs |
| | | who moved out of the given location |
| | | area since previous notification. |
| Triggering event | O | Identity of the event that triggered |
| | | the sending of the notification |

NOTE:
Any one of these shall be present.

FIG. 4 illustrates a sequence diagram in which the VAL server (100) requests a SEAL group management (GM) server (200b) to group all the UEs in the area defined by the VAL service area, according to an embodiment. The pre-conditions are as follows:
a) The group management client, the group management server (200b), the VAL server (100), the location management server (200a) and the VAL group members belong to the same VAL system.
b) The authorized VAL user/UE/administrator is not aware of the users' or UE identities which will be combined to form the VAL group.

In step 1, the group management client or the VAL server (100) requests location-based group create operation to the group management server (200b). The location criteria for determining the identities of the users or UEs to be combined shall (or, may) be included in this message (e.g., location-based group create message) and the location-based group create message shall (or, may) include VAL Service Area Identification which is the location criteria as one of geographical location information. In step 2, the group management server (200b) requests the location management server (200a) for obtaining the users or UEs corresponding to the location information. In step 3, the location management server (200a) composes (or, identify) the list of users or UEs within the requested location. In step 4, the group management server (200b) receives the composed list of users or UEs from the location management server (200a). In step 5, during the group creation, the group management server (200b) creates and stores the information of the location-based group. The group management server (200b) performs the check on the policies (e.g., maximum limit of the total number of VAL group members for the VAL group(s)). If an external group identifier (e.g., in case that the external group identifier is identified), identifying the member UEs of the VAL group at the 3GPP core network is available, then the external group ID is stored in the newly created VAL group's configuration information. In step 6, the group management server (200b) provides (or, transmits) a location-based group creation response to the group management client or the VAL server (100).

Table 4.1 describes the information flow location-based group creation request from the group management client or VAL server (100) to the group management server (200b).

TABLE 4.1

| Information element | Status | Description |
|---|---|---|
| Requester Identity | M | The identity of the group management |
| | | client performing the request. |
| Location criteria | M | Criteria to combine Users or UEs in a |
| | | location. Here, VAL Service Area ID is |
| | | added as one of a location information |
| VAL service ID list | O | List of VAL services whose service |
| (see NOTE 1) | | communications are to be enabled on |
| | | the group. |
| VAL service specific | O | Placeholder for VAL service specific |
| information (see | | information |
| NOTE 2) | | |

NOTE 1:
This information element shall be included in the message for creating a group configured for multiple VAL services.
NOTE 2:
The details of this information element are specified in VAL service specific specification and are out of scope of the present document.

Table 4.2 describes the information flow location-based group creation response from the group management server (200b) to the group management client or VAL server (100).

TABLE 4.2

| Information | | |
|---|---|---|
| element | Status | Description |
| VAL group ID | M | VAL group ID of the group |
| | (see | |
| | NOTE) | |
| Result | M | Indicates the success or failure for the |
| | | operation |

NOTE:
If the Result information element indicates failure then the value of VAL group ID information element has no meaning.

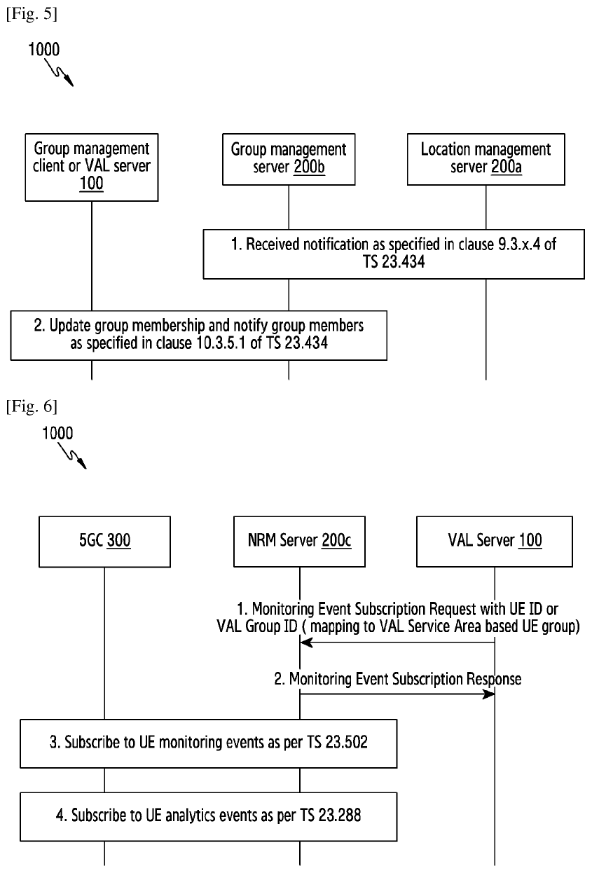

FIG. 5 illustrates a sequence diagram in which the SEAL GM server (200b) notifies the VAL server (100) on updating of the newer UEs/moving out of older UEs from the group in accordance with the UE location from the SEAL LM server (200a), according to an embodiment. The pre-conditions are as follows:
a) The group management client, the group management server (200b), the VAL server (100), the location management server (200a) and the VAL group members belong to the same VAL system.
b) The location-based group has been created as specified in FIG. 4.
c) The group management server (200b) has subscribed to monitor UEs moving in or out of the fixed location area.

In step 1, the group management server (200b) receives location area monitoring notification from the location management server (200a). In step 2, the group management server (200b) updates the group members and sends notification as specified in clause 10.3.5.1 of TS 23.434. For example, the membership of a specific VAL group is changed at group management server (by a group management server). The group management server notifies the VAL server(s) regarding the group membership change with the information of the updated group members. The group management server updates the group management clients of the VAL users/UEs who have been added to or removed from the group. The group management client requests to retrieve the relevant group configurations from group management server, if the user or UE is added to the group. If the user or UE is deleted from the group, the locally stored group configurations in the VAL UE may be removed.

Table 5.1 describes the information flow group membership notification from the group management server (200b) to the VAL server (100)/Group Manager Client.

TABLE 5.1

| Information | | |
|---|---|---|
| element | Status | Description |
| VAL group ID | M | Identity of the VAL group |
| Identity | M | List of identities of the VAL users and |
| | | VAL UEs affected by this operation |
| Operations | M | Add to or delete from the group |
| VAL service specific | O | Placeholder for VAL service specific |
| information (NOTE) | | information |

NOTE:
The details of this information element are specified in VAL service specific specification and are out of scope of the present document.

Table 5.2 describes the information flow group membership notification from the group management server (200b) to the group management client.

TABLE 5.2

| Information element | Status | Description |
|---|---|---|
| VAL group ID | M | Identity of the VAL group |
| Operations | M | Add to or delete from the group |

FIG. 6 illustrates a sequence diagram in which the VAL server (100) requests the SEAL servers (e.g., SEAL NRM) (200c) to treat all UEs in the service area as one group identified by the VAL service area identification and monitor/update as one group, according to an embodiment. The pre-conditions are as follows:

a) The NRM server (200c) is authorized to consume the core network services (Monitoring events as specified in 3GPP TS 23.502 and Analytics services as specified in 3GPP TS 23.288).

According to an embodiment, in step 1, the VAL server (100) sends (or, transmits) Monitoring Events Subscription request to the NRM server (200c), requesting the NRM server (200c) to monitor the events related to the VAL UE(s) or VAL Group ID as a group of VAL UEs as per the subscription request, and shall (or, may) include the information related to the events that the VAL server (100) is interested in.

According to an embodiment, in step 2, the NRM server (200c) shall (or, may) check if (or, in case that) the VAL server (100) is authorized to initiate the Monitoring Events Subscription request and if authorized shall respond with Monitoring Events Subscription Response message, indicating the successful subscription status along with subscription information to the VAL server (100). The VAL service ID may be used by the NRM server (200c) to derive event specific information in 3GPP core network services (e.g., QoS group ID (if received) to the External Group ID known to the 3GPP core network.

NOTE: The mapping between Monitoring profile ID and event details in the NRM server (200c) can be pre-configured and/or dynamically built based on VAL server request with explicitly sent event details, which is requirement in analytics event subscription), based on e.g., local configuration. The NRM server (200c) maps the VAL implementation specific.

According to an embodiment, in step 3, based on the events of interest information in the subscription request message, if applicable, the NRM server (200c) shall subscribe to the UE monitoring events (like, LOSS_OF_CONNECTIVITY, COMMUNICATION_FAILURE etc.) for the set of UEs (VAL UEs) in the subscription request, as specified in 3GPP TS 23.502. In step 4, based on the events of interest information in the subscription request message, if applicable, the NRM server (200c) shall (or, may) subscribe to the UE analytics events (e.g., ABNORMAL_BEHAVIOUR etc.) for the set of UEs (VAL UEs) in the subscription request, as specified in 3GPP TS 23.288.

Table 6.1 describes the information flow from the VAL server (100) to the NRM server (200c) for monitoring events subscription request.

TABLE 6.1

| Information | | |
|---|---|---|
| element | Status | Description |
| Identities list | O | List of VAL users or VAL UEs |
| | (see NOTE 1) | whose events monitoring is |
| | | requested. |
| VAL group ID | O | VAL group ID of the VAL UE |
| | (see NOTE 1) | group of target UEs. This can be a |
| | | group identified by VAL Service |
| | | Area ID in Group Management |
| | | server dynamically |
| VAL service ID | O | VAL service ID. |
| Monitoring | O | The monitoring profile ID, which |
| profile ID | (see NOTE 2) | identifies a list of monitoring |
| | | and/or analytics events. |
| Validity | O | The temporal and/or spatial |
| conditions | | conditions applied for the events |
| | | to be considered as valid. |
| Event Details | O | List of monitoring and/or analytics |
| | (see NOTE 2) | events that the VAL server is |
| | | interested in. |

NOTE 1:
For identifying the target UE(s), either a list of VAL users/UEs or a group of VAL UEs shall be provided.
NOTE 2:
Either Event Details or Monitoring profile ID is present.

Table 6.2 describes the information flow from the NRM server (200c) to the VAL server (100) for Monitoring Events Subscription response.

TABLE 6.2

| Information element | Status | Description |
|---|---|---|
| Subscription status | M | It indicates the subscription result |
| Monitoring | O | It indicates the monitoring profile |
| profile ID | | identifier. It is present when Event |
| | | Details are provided in the Monitoring |
| | | Events Subscription request. |

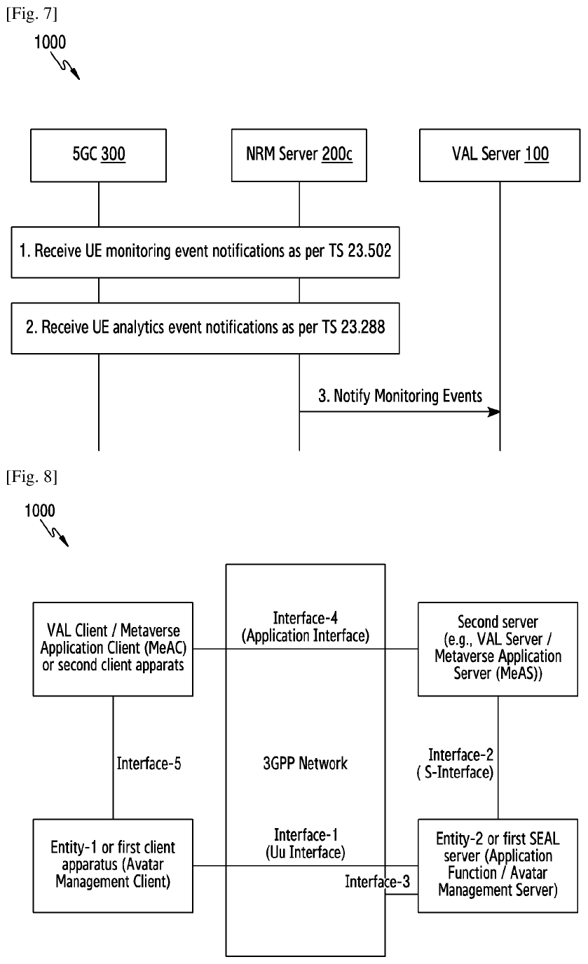

FIG. 7 illustrates a sequence diagram in which the SEAL server (e.g., SEAL NRM) (200c) receive/update notifications/configurations to all the members of the group identified by the VAL service area ID, according to an embodiment.

The NRM server (200c) notifies (or, informs) the VAL server (100) with VAL UE(s) related events. The pre-conditions are as follows:
a) The VAL server (100) has subscribed with NRM server (200c) using the Monitoring Events Subscription Procedure (as depicted in FIG. 6).

According to an embodiment, if applicable, in step 1, the NRM server (200c) receives the VAL UE related monitoring event notifications from the 3GPP core network as specified in 3GPP TS 23.502.

According to an embodiment, if applicable, in step 2, the NRM server (200c) receives the VAL UE related Analytics event notifications from the 3GPP core network as specified in 3GPP TS 23.288.

According to an embodiment, in step 3, the NRM server (200c) notifies the VAL server (100) about the events related to the VAL UE in Notify Monitoring Events message. In case that multiple events are to be notified, then the NRM server (200c) may aggregate the notifications and send (or, transmit) to the VAL server (100).

Table 7.1 describes the information flow from the NRM server (200c) to the VAL server (100) on notification of monitoring events.

TABLE 7.1

| Information element | Status | Description |
|---|---|---|
| EventDetails | | List of events related to VAL UE(s). |
| > identity | M | VAL UE for which the events are |
| | | related to. |
| > events | M | List of Monitoring and Analytics |
| | | events related to the VAL UE. |
| Timestamp | O | The timestamp for the monitoring and |
| | | analytics events |

Event-triggered location reporting procedure: The location management server (200a) provides location reporting configuration to the location management clients, indicating what information the location management server (200a) expects and what events will trigger the sending of this information to the location management server (200a). The decision to report location information can be triggered at the location management client by different conditions (e.g., the reception of the location reporting configuration, initial registration, distance travelled, elapsed time, cell change, MBMS SAI change, MBMS session change, Vertical Application Layer Service Area change which here refers to MBMS SAI change, leaving a specific VAL Service Area, which herein refers to leaving a MBMS bearer service area, tracking area change, PLMN change, call initiation, or other types of events such as emergency). The location report may include information described as ECGI, MBMS SAIs, geographic coordinates, and/or other location information.

Table 8.1 describes the information flow MBMS bearer announcement from the NRM server (200c) to the NRM client.

TABLE 8.1

| Information element | Status | Description |
|---|---|---|
| TMGI | M | TMGI information |
| Alternative TMGI | O | A list of additional alternative TMGI |
| | | may be included and used in roaming |
| | | scenarios. |
| QCI | O | QCI information used by the ProSe |
| | | UE-Network Relay to determine the |
| | | ProSe Per-Packet Priority value to be |
| | | applied for the multicast packets |
| | | relayed to Remote UE over PC5 |
| List of VAL | M | A list of service area identifier for the |
| service area | | applicable MBMS broadcast area. |
| identifier | | |
| Frequency | O | Identification of frequency if multi |
| | | carrier support is provided |
| SDP information | M | SDP with media and application |
| | | control information applicable to |
| | | groups that can use this bearer (e.g. |
| | | codec, protocol id, FEC information) |
| Monitoring state | O | The monitoring state is used to control |
| | | if the client is actively monitoring the |
| | | MBMS bearer quality or not. |
| Announcement | O | Indicate if the NRM server requires an |
| acknowledgment | | acknowledgement of the MBMS bearer |
| | | announcement. |
| Unicast status | O | An indication that the listening status |
| | | of the unicast bearer is requested. |
| ROHC | O | Indicate the usage of ROHC and |
| information | | provide the parameters of the ROHC |
| | | channel to signal to the ROHC decoder. |

NOTE:
When MBMS bearer announcement is done on a MBMS bearer all attributes above are optional except the TMGI.

### End-to-End QoS Management Request:

Table 8.2 describes the information flow end-to-end QoS management request from the NRM client to the NRM server (200c).

TABLE 8.2

| Information | | |
|---|---|---|
| element | Status | Description |
| List of VAL UEs | M | List of VAL UEs for whom the end-to- |
| | | end QoS management occurs |
| >VAL UE/user ID | M | Identity of the VAL UE |
| > IP address | M | IP address of the VAL UE |
| VAL service ID | O | The VAL service identity for whom the |
| | | end-to-end QoS management occurs. |
| End-to-end Qos | O | The application QoS requirements / |
| requirements | | KPIs (latency, error rate, or the like) |
| | | for the end-to-end session. |
| | | This may optionally include |
| | | information which will support the |
| | | NRM server to identify the per session |
| | | QoS requirements (e.g., a flag |
| | | indicating the use of HD video for |
| | | assisting the end-to-end session, a |
| | | video resolution/encoding required for |
| | | the HD video). |
| VAL Service | O | The VAL Service area where the QoS |
| area | | management request applies. This can |
| | | be geographical area, or topological |
| | | area. |
| Time validity | O | The time of validity of the |
| | | requirement. |

### Changes in Data Structures—Data Semantics:

### Location Info Reports:

The <location-info> element is the root element of the XML document. The <location-info> element contains the <identity>, <subscription>, <request>, <configuration> and <report> sub-elements.

<reports>, an element contains one or more <loc-info-report> elements. Each <loc-info-report> element contains the following sub-elements:
1) <VAL-user-id>, an element contains (or, includes) the identity of a VAL user in the identities list;
2) <latest-location>, an element contains at least one of the following sub-elements:
i) <latest-serving-NCGI>, an optional element containing the NR cell global identity (NCGI) of the serving cell coded as specified in clause 19.6A in 3GPP TS 23.003;
ii) <neighbouring-NCGI>, an optional element that can occur multiple times. It contains the NCGI of any neighbouring cell the SLM-C can detect
iii) <mbms VAL-service-area-id>, an optional element containing the VAL service area id the SLM-C is using It can be any VAL service area id for any type of VAL Services like MBMS, MBSFN, quality of service (QoS), traffic control, MCPTX service, V2X service, FF service, MBMS service area id the SLM-C is using coded as specified in clause 15.3 in 3GPP TS 23.003 for service area identifier (SAI) or MBSFN area Id that needs to be reported;
iv) <VAL Service Type> element, an optional element specifying the VAL Service type like MBMS, MBSFN, Mission Critical Push-to-Anything (MCPTX), vehicle to everything (V2X), FF, internet of things (IoT) that the VAL Service area Id needs to be reported; and
v) <latest-coordinate>, an optional element containing the longitude and latitude coded as specified in clause 6.1 in 3GPP TS 23.032;

### Location Info Report:

<report> is a mandatory element used to include the location report. It contains a <report-id> attribute. The <report-id> attribute is used to return the value in the <request-id> attribute in the <request> element. The <report> element contains the following sub-elements:
a) <trigger-id>, a mandatory element which can occur multiple times that contain the value of the <trigger-id> attribute associated with a trigger that has fired; and
b) <current-location>, a mandatory element that contains the location information. The <current-location> element contains the following sub-elements:
1) <current-serving-NCGI>, an optional element containing the NR cell global identity (NCGI) of the serving cell coded as specified in clause 19.6A in 3GPP TS 23.003;
2) <neighbouring-NCGI>, an optional element that can occur multiple times. It contains the NCGI of any neighbouring cell the SLM-C can detect;
3) <mbmsval-service-area-id>, an optional element containing the VAL MBMS service area id the SLM-C is using as per VAL service type, it correspondingly defined. For e.g., for MBMS it is used as specified in clause 15.3 in 3GPP TS 23.003 for service area identifier (SAI);
4) <val-service-type>, an optional element containing the VAL service type covered by the above service area id. This can be MBMS, MBSFN, MCPTX, V2X, FF etc.;
5) <current-coordinate>, an optional element containing the longitude and latitude coded as specified in clause 6.1 in 3GPP TS 23.032.

### Configuration:

<configuration> is an element with a <configuration-scope> attribute that can have the value “Full” or “Update”. The value “Full” means that the <configuration> element contains the full location configuration which replaces any previous location configuration. The value “Update” means that the location configuration is an addition to any previous location configuration. To remove configuration elements a “Full” configuration is needed. The <configuration> element contains the following sub-elements:
a) <location-information>, an optional element that specifies the location information. The <location-information> has the sub-elements:
1) <serving-NCGI>, an optional element containing the NR cell global identity (NCGI) of the serving cell coded as specified in clause 19.6A in 3GPP TS 23.003;
2) <neighbouring-NCGI>, an optional element that can occur multiple times. It contains the NCGI of any neighbouring cell the SLM-C can detect;
3) <val-service-area-id>, an optional element containing VAL service area id that the SLM-C is using.
4) <val-service-type>, an optional element containing the VAL service type covered by the above service area id. This can be MBMS, MBSFN, MCPTX, V2X, FF etc.
5) <current-geographical-coordinate>, an optional element containing the longitude and latitude coded as specified in clause 6.1 in 3GPP TS 23.032;

### Triggering Criteria:

<triggering-criteria>, an optional element specifying the triggers for the SLM-C to request a location report of a VAL user, a VAL client or a VAL group. The <triggering-criteria> element contains at least one of the following sub-elements:
<val-service-area-change>, an optional element specifying what VAL Service Arca changes trigger a request for a location report. This element consists of the following sub-elements:
i) <any-val-service-area-change>, an optional element. The presence of this element specifies that any VAL Service area change is a trigger for a request for a location report. This element contains a mandatory <trigger-id> attribute that shall be set to a unique string;
ii) <enter-specific-val-service-area>, an optional element specifying a VAL Service area ID which when entered triggers a request for a location report. This element contains a mandatory <trigger-id> attribute that shall be set to a unique string; and
iii) <enter-specific-val-service-area-type>, the VAL Service type covered by the above service area id. This can be MBMS, MBSFN, MCPTX, V2X, FF etc.
iv) <exit-specific-val-service-area>, an optional element specifying a VAL Service area ID which when exited triggers a request for a location report. This element contains a mandatory <trigger-id> attribute that shall be set to a unique string;
v) <exit-specific-val-service-area-type>, the VAL Service type covered by the above service area id. This can be MBMS, MBSFN, MCPTX, V2X, FF etc.

The sub-elements ii and iii can be repeated for each VAL Service area and types for entering criteria and same for sub-elements iv and v for exit criteria.

### Report Request:

<report-request> is a mandatory element used to include the requested location report. The <report-request> element contains at least one of the following sub-elements:
a) <current-location>, an optional element that contains the location information. The <current-location> element contains the following sub-elements:
1) <current-serving-NCGI>, an optional element containing (or, including) the NR cell global identity (NCGI) of the serving cell coded as specified in clause 19.6A in 3GPP TS 23.003;
2) <neighbouring-NCGI>, an optional element that can occur multiple times. It contains the NCGI of any neighbouring cell the SLM-C can (or, may) detect;
3) <mbmsval-service-area-id>, an optional element containing the VAL service area id that the SLM-C is using. The VAL can be an MBMS service area id is coded as specified in clause 15.3 in 3GPP TS 23.003 for service area identifier (SAI); and
4) <val-service-type>, an optional element containing the VAL service type covered by the above service area id. This can be MBMS, MBSFN, MCPTX, V2X, FF etc.
5) <current-coordinate>, an optional element containing the longitude and latitude coded as specified in clause 6.1 in 3GPP TS 23.032.

<triggering-criteria> is an optional element specifying the triggers for the SLM-C to request a location report of a VAL user, a VAL client and/or a VAL group. The <triggering-criteria> element contains at least one of the following sub-elements:
<val-service-area-change>, an optional element specifying what VAL Service Area changes trigger a request for a location report. This element consists of the following sub-elements:
i) <any-val-service-area-change>, an optional element. The presence of this element specifies that any VAL Service area change is a trigger for a request for a location report. This element contains a mandatory <trigger-id> attribute that shall (or, may) be set to a unique string;
ii) <enter-specific-val-service-area>, an optional element specifying a VAL Service area ID which when entered triggers a request for a location report. This element contains a mandatory <trigger-id> attribute that shall be set to a unique string; and
iii) <enter-specific-val-service-area-type>, the VAL Service type covered by the above service area id. This can be MBMS, MBSFN, MCPTX, V2X, FF etc.
iv) <exit-specific-val-service-area>, an optional element specifying a VAL Service area ID which when exited triggers a request for a location report. This element contains a mandatory <trigger-id> attribute that shall be set to a unique string;
v) <exit-specific-val-service-area-type>, the VAL Service type covered by the above service area id. This can be MBMS, MBSFN, MCPTX, V2X, FF etc.

The sub-elements ii and iii can be repeated for each VAL Service area and types for entering criteria and same for sub-elements iv and v for exit criteria

Embodiments herein enable case of use for the VAL server users to work with SEAL in relation with its Service Area. For example, VAL Server Administrator registers one time the service area-geographical co-ordinates mapping and let all other users of various SEAL services to seamlessly communicate with Service Area Identifier. By this way, even the change in the service area is one time notified by VAL Server Administrator and will be automatically affected without change in any of the APIs of both VAL and SEAL. The analytics pertaining to the UEs served by a particular service area through SEAL NRM help in improving the VAL Service. The dynamic UE groupings in SEAL GM based on the VAL Service Area without a single change of code in VAL and SEAL GM work seamlessly even if the service area changes and even when UEs dynamically move in and out, added and removed. Embodiments herein enable the VAL Service Provider to message all of the UEs in a particular service area in case of any emergency or notification of changes in billing or service changes.

Embodiments herein empower consumers as VAL Service users to pass on any actions or information very easily to all the members of the group. The VAL service server or the VAL Admin may register the mapping of VAL service area ID and its corresponding geographical area to the SEAL server (200). Registration of these mappings can be done through configuration like VAL server profile information or any other means. VAL domain may register these mappings to one SEAL server (200) and that SEAL server (200) can propagate these mappings to all other SEAL servers in the domain. The registration of these mapping may be done by the VAL server (100) to the SEAL server (200) by an API call and can update these mappings by invoking these APIs with updated geographical areas. More than one VAL service area can be registered by each VAL server (100). The SEAL service may expose APIs to create, update or delete the VAL service Area ID and geographical area mapping. The VAL service Area ID may either be supplied (or, provided) by the VAL server (100) or the SEAL service can generate the VAL service Area ID and share it with the VAL server (100).

FIG. 8 is an illustration of a functional model for avatar management system, according to an embodiment. The avatar management system may also be called as Digital Representation Management System or any other suitable name. The Entity-1 (e.g., client apparatus (1200)) communicates with the Entity-2 (e.g., SEAL server (200)) over the Interface-1 (Uu) reference point. The Interface-1 supports both unicast and multicast delivery modes. The Entity-1 provides the service enabler layer support functions for Avatar management to the VAL client(s) or Metaverse Application Client (MeAC) over Interface-5 reference point. The VAL servers or Metaverse Application Server (MeAS) communicate with the Entity-2 over the Interface-2 (S) reference points. The Entity-2 may communicate with the underlying 3GPP network systems using Interface-3 reference point. The Interface-3 is the 3GPP interfaces towards NEF or towards a specific NF as specified by the 3GPP network system.

The Entity-2 provides Avatar management service to MeAC, MeAS or 3GPP NF or any other application function. It allows the consumer of the service to create, register, update, fetch, and delete the Avatar and associated information or properties or configuration of Avatars. Avatar may be created based on user's request or based on request from core network or from VAL server or from MeAS. The Avatar may be create for a single user or it can be created and shared for multiple users. For avatar which are created for multiple users, the users may use the Avatar at a same time simultaneously or one at a time depending on the application requirement. The Entity-2 stores the Avatar and its related properties and configuration. The Avatar properties and configuration includes, for example, but not limited to, Avatar ID, associated User list, current status, shape, size, color, virtual position, current speed, direction of movement, current location in real world, access rights, authentication information, security tokens, allowed application list, allowed location, wallet list, one or more predictive model, life time, input methods, location history, used application history, life time, expiry time, or any such information.
a) The Avatar ID is used to uniquely identify the Avatar.
b) The Associated user list contains list of one or more user's identity who are allowed to use the Avatar.
c) The current status indicates whether the avatar is currently in use or not (i.e. free).
d) The allowed application list specifies the list of the application identifiers for which the Avatar can be used.
e) The allowed location-specifies the location range of the user whether the Avatar can be used.
f) One or more predictive model specifies the model used to train the Avatar based on input data received from user or user's sensor device or user's data received in any other form.
g) The life time indicates the time since the Avatar is created and registered.
h) The expiry time indicates the time till when the Avatar can be used by the user.
i) The wallet list specifies the wallet ID associated with user's finance source (like bank or credit card) which allows user to purchase items in the metaverse using the avatar.
j) The access rights, authentication information and security tokens are used to provide secure access of Avatar and its related information to the consumer (i.e. user or MeAS or VAL server or 3GPP NFs).

In an embodiment, the avatar may be also be called as a digital representation or replica or alter egos or digital assets or any other name. In an embodiment, the Entity-2 can be called as Avatar Management Server, Digital Representation Management Server or Replica Management Server or any other suitable name.

In an embodiment, the Entity-1 can be called as Avatar Management Client, Digital Representation Management Client or Replica Management Client or any other suitable name. In an embodiment, the Entity-1 can be part of SEAL configuration management client or SEAL group management client or any other SEAL client.

In an embodiment, the Entity-2 (Avatar Management Server) can be part of 3GPP core network as a network function. In such case, the Entity-2 will have interface with other 3GPP NFs (like Session Management Function (SMF) entity, Access and Mobility Management Function (AMF) entity, Unified Data Management (UDM) entity, Network Exposure Function (NEF) entity, etc.,). In an embodiment, the Entity-2 may be part of the SEAL configuration management server or the SEAL group management server or any other SEAL server.

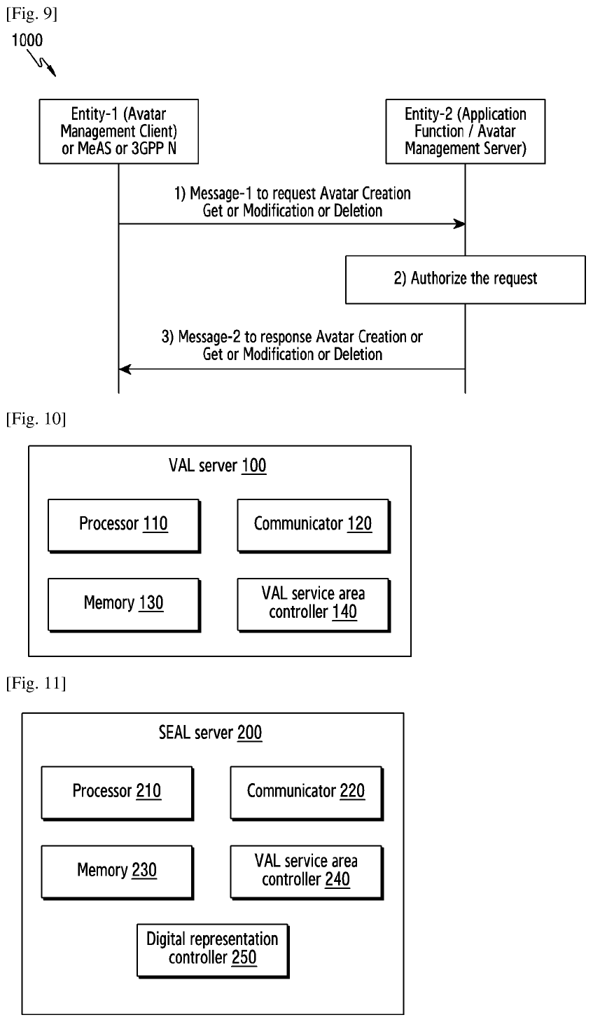

FIG. 9 illustrates a sequence diagram in which operations of the avatar management system is explained, according to an embodiment. Referring to FIG. 9, the procedure to create or get or modify or delete the Avatar or digital representation. The Entity-2 may expose the API for the consumer to create, register, modify or delete the Avatar and associated information or properties or configuration of Avatars. The consumer may be Entity-1 or MeAS or 3GPP NF (e.g. SMF, AMF, UDM, NEF, etc.,) or VAL server. In step-1, the Entity-1 or MeAS or 3GPP NF or VAL server sends request message to create or modify or delete the Avatar. In an embodiment, the request message is to manage the Avatar. The request also indicates the operation being requested to be performed by the Entity-2.

In case that the request is to create or register the Avatar, the consumer includes required security credentials and other parameters to create or register the Avatar. The security credentials includes security token. The other required parameter includes Avatar details and properties-like avatar ID, associated User list, current status, shape, size, color, virtual position, current speed, direction of movement, current location in real world, access rights, authentication information, security tokens, allowed application list, allowed location, wallet list, one or more predictive model, life time, input methods, location history, used application history, requested expiry time, etc.

In case that the request is to get the Avatar details then the request includes Avatar identity. If the request is to delete the Avatar then the request includes Avatar identity.

In step-2, the Entity-2 authenticate and authorizes the user. If user is allowed to perform the operation then based on requested operation, the Entity-2 performs one of the following action.

In case that the request is to create or register Avatar, then the Entity-2 creates the resource to store the Avatar details. The Entity-2 stores the configuration as received in the request. The entity-2 also initialize current speed, direction of movement, current location in real world, location history, used application history, etc. to their default values. In an embodiment, the information or properties or configuration related to avatar is stored into an configuration file or any other data store.

In case that the request is to modify the Avatar then the Entity-2 checks whether the Avatar is present or not based on provided Avatar ID. If Avatar is present, the Entity-2 updates the resource with the new parameters as provided in the request message.

In case that the request is to delete the Avatar then the Entity-2 checks whether the Avatar is present or not based on provided Avatar ID. If Avatar is present, then the Entity-2 deletes the Avatar and associated resources and associated information or properties or configuration related to avatar.

In case that the request is to get the Avatar details then the Entity-2 checks whether the Avatar is present or not based on provided Avatar ID. If Avatar is present, then the Entity-2 prepares the Avatar details to include it in response message.

In step-3, the Entity-2 sends (or, transmits) the appropriate response based on the request. The response also includes whether the result of the requested operation is success or failed. If the request operation is success, the Entity-2 includes following details in the response.

In case that the request is to create or register Avatar, the newly created Avatar ID along with Avatar expiration time is included. If the request is to get Avatar details, then all parameters of the avatar is included. In an embodiment, Avatar management operations can be specified as a separate procedures for create, get, modify and delete. In an embodiment, Avatar management operations can be part of SEAL configuration management operations or SEAL group management operations or any other SEAL server operations.

In case that the request is to modify the avatar then the request includes Avatar identity along with parameters to modify. The parameters to modify includes associated User list, current status, shape, size, color, virtual position, access rights, authentication information, security tokens, allowed application list, allowed location, wallet list, one or more predictive model, input methods, and/or requested expiry time, etc.,

FIG. 10 illustrates various hardware components of the VAL server (100), according to the embodiments as disclosed herein. In an embodiment, the VAL server (100) includes a processor (110), a communicator (120), a memory (130) and/or a VAL service area controller (140). The processor (110) is coupled with the communicator (120), the memory (130) and the VAL service area controller (140).

According to an embodiment, the VAL service area controller (140) configures the VAL service area ID based on the VAL service area. Further, the VAL service area controller (140) registers the mapping of the VAL service area ID and the associated geographical area (or, geographical information) to the SEAL server (200). The mapping of the VAL service area ID and the geographical area associated with the VAL service area ID is registered through the configuration information. The SEAL server (200) propagates the mapping of the VAL service area ID and the geographical area associated with the VAL service area ID to all other SEAL servers in the SEAL domain.

In an embodiment, the VAL service area controller (140) creates mapping of the VAL service area ID and the geographical area or modifies mapping of the geographical area associated with the VAL service area ID, or updates mapping of the VAL service area ID and the geographical area, or deletes mapping of the VAL service area ID and the geographical area

Further, the VAL service area controller (140) sends (or, transmits) the get UE information request to the SEAL server (200). The get UE information request includes the location information, the VAL service area ID and the application defined proximity range. The SEAL server (200) determines (or, identify) that location area associated with the UE is within the application defined proximity range of the location information. Based on the get UE information request, the VAL service area controller (140) receives the get UE information response from the SEAL server (200). The get UE information response includes a list of UEs and a location information corresponding to the list of UEs residing in the geographical area represented by the VAL service area ID.

Further, the VAL service area controller (140) sends (or, transmits) the location area monitoring subscription request to the SEAL server (200) to subscribe to the list of UEs moving in or moving out of the location area. The location area monitoring subscription request includes the identify of at least one of the VAL server (100), the VAL UE, and the SEAL server (200), the location information criteria comprising at least one of a geographic location information, the VAL service area ID denoting the geographical location information, and the reference UE along with the application defined proximity range from a reference UE, the time interval between consecutive reports, the immediate report indicator and/or the triggering event. Further, the VAL service area controller (140) receives the location area monitoring subscription response from the SEAL server (200) based on the location area monitoring subscription request in response to the SEAL server (200) determines that the VAL server (100) is authorized to initiate the location area monitoring subscription request.

Further, the VAL service area controller (140) sends the location based group creation request including the VAL service ID to the first SEAL server (200). Further, the VAL service area controller (140) receives the location based group creation response message from the first SEAL server (200) based on the location based group creation request.

The VAL service area controller (140) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (110) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (110) may include multiple cores and is configured to execute the instructions stored in the memory (130).

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

Although the FIG. 10 illustrates various hardware components of the VAL server (100) but it is to be understood that other embodiments are not limited thereon. In other embodiments, the VAL server (100) may include less or more number of components. Further, the labels or names of the components are used only for illustrative purpose and does not limit the scope of the invention. One or more components can be combined together to perform same or substantially similar function in the VAL server (100).

FIG. 11 illustrates various hardware components of the SEAL server (200), according to an embodiment. In an embodiment, the SEAL server (200) includes a processor (210), a communicator (220), a memory (230), a VAL service area controller (240), and/or a digital representation controller (250). The processor (210) is coupled with the communicator (220), the memory (230), the VAL service area controller (240), and the digital representation controller (250).

According to an embodiment, the VAL service area controller (240) receives and storing the mapping of the VAL service area ID with the geographical area. In an embodiment, the VAL service area controller (240) performs at least one of: creates mapping of the VAL service area ID and the geographical area, modifies mapping of the VAL service area ID and the geographical area, updates mapping of the VAL service area ID and the geographical area, and deletes mapping of the VAL service area ID and the geographical area upon detecting the change in a VAL service area.

According to an embodiment, the VAL service area controller (240) receives the get UE information request from the VAL server (200). The get UE information request includes the location information, the VAL service area ID and the application defined proximity range. Further, the VAL service area controller (240) determines that location area associated with the VAL service area ID. Further, the VAL service area controller (240) sends the get UE information response to the VAL server (100) based on the get UE information request. The get UE information response includes the list of UEs residing in the geographical and the location information corresponding to the list of UEs.

According to an embodiment, the VAL service area controller (240) receives the location area monitoring subscription request from the VAL server (100) to subscribe to the list of UEs moving in or moving out of the specific location area. The location area monitoring subscription request includes at least one of the identify of at least one of the VAL server (100), the VAL UE, and the SEAL server (200), the location information criteria including at least one of the geographic location information, the VAL service area ID denoting the geographical location information, and the reference UE along with the application defined proximity range from the reference UE, the time interval between consecutive reports, the immediate report indicator and at least one triggering event. Further, the VAL service area controller (240) determines that the VAL server (100) is authorized to initiate the location area monitoring subscription request. Further, the VAL service area controller (240) sends the location area monitoring subscription response to the VAL server (100) based on the location area monitoring subscription request.

According to an embodiment, the VAL service area controller (240) receives the location based group creation request including the VAL service ID from the VAL server (100). Based on the location based group creation request, the VAL service area controller (240) sends the location based group creation response message to the VAL server (100).

The VAL service area controller (240) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The digital representation controller (250) receives the request message to perform the operation associated with the digital representation along with properties and related information of digital representation from the client apparatus. The digital representation can be, for example, but not limited to, the avatar, the alter egos, the digital assets, the digital wallet or any other suitable name for the digital representation. The operation can be, for example, but not limited to a create operation, a get operation, a modification operation and a delete operation. The request message includes an digital representation ID, the operation and the parameter, where the parameter includes at least one of the user list, current status, shape, size, color, virtual position, access right, authentication information, a security token, allowed application list, allowed location, wallet list, a predictive model, an input method, life time, expiry time, speed, location history, and an application history.

According to an embodiment, the digital representation controller (250) authorizes the request message at the SEAL server (200). Further, the digital representation controller (250) sends a response message in response to performing the operation associated with the digital representation to the client apparatus based on the request message.

The digital representation controller (250) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (210) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (210) may include multiple cores and is configured to execute the instructions stored in the memory (130).

Further, the processor (210) is configured to execute instructions stored in the memory (230) and to perform various processes. The communicator (220) is configured for communicating internally between internal hardware components and with external devices via one or more networks. The memory (230) also stores instructions to be executed by the processor (210). The memory (230) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (230) may, in some examples, be considered a non-transitory storage medium. The term “non-transitory” may indicate that the storage medium is not embodied in a carrier wave or a propagated signal. However, the term “non-transitory” should not be interpreted that the memory (230) is non-movable. In certain examples, a non-transitory storage medium may store data that can, over time, change (e.g., in Random Access Memory (RAM) or cache).

Although the FIG. 11 shows various hardware components of the SEAL server (200) but it is to be understood that other embodiments are not limited thereon. In other embodiments, the SEAL server (200) may include less or more number of components. Further, the labels or names of the components are used only for illustrative purpose and does not limit the scope of the invention. One or more components can be combined together to perform same or substantially similar function in the SEAL server (200).

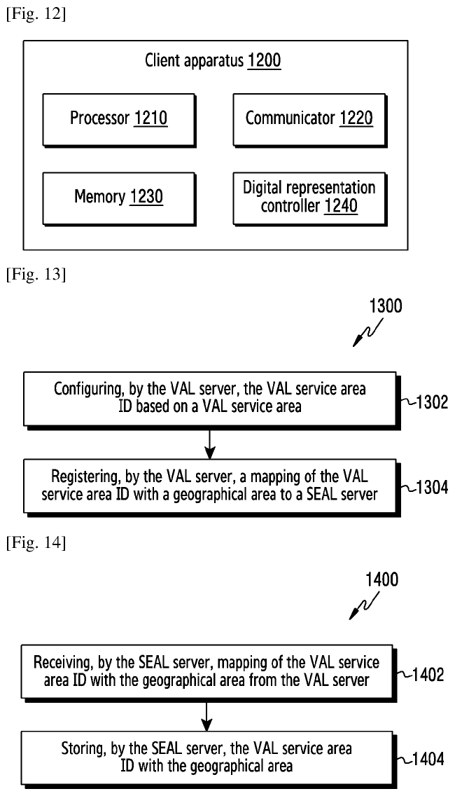

FIG. 12 illustrates various hardware components of a client apparatus (1200), according to the embodiments as disclosed herein. In an embodiment, the client apparatus (1200) includes a processor (1210), a communicator (1220), a memory (1230) and/or a digital representation controller (1240). The processor (1210) is coupled with the communicator (1220), the memory (1230) and the digital representation controller (1240).

The digital representation controller (1240) sends the request message to perform the operation associated with the digital representation along with properties and related information of digital representation to the SEAL server (200). The operation can be, for example, but not limited to the create operation, the get operation, the modification operation and the delete operation. Based on the request message, the digital representation controller (1240) receives the response message in response to performing the operation associated with the digital representation from the SEAL server (200) upon authorizing the request message at the SEAL server (200).

The digital representation controller (1240) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (1210) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (1210) may include multiple cores and is configured to execute the instructions stored in the memory (1230).

Further, the processor (1210) is configured to execute instructions stored in the memory (1230) and to perform various processes. The communicator (1220) is configured for communicating internally between internal hardware components and with external devices via one or more networks. The memory (1230) also stores instructions to be executed by the processor (1210). The memory (1230) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (1230) may, in some examples, be considered a non-transitory storage medium. The term “non-transitory” may indicate that the storage medium is not embodied in a carrier wave or a propagated signal. However, the term “non-transitory” should not be interpreted that the memory (1230) is non-movable. In certain examples, a non-transitory storage medium may store data that can, over time, change (e.g., in Random Access Memory (RAM) or cache).

Although the FIG. 12 shows various hardware components of the client apparatus (1200) but it is to be understood that other embodiments are not limited thereon. In other embodiments, the client apparatus 1200 may include less or more number of components. Further, the labels or names of the components are used only for illustrative purpose and does not limit the scope of the invention. One or more components can be combined together to perform same or substantially similar function in the client apparatus 1200.

FIG. 13 is a flow chart 1300 illustrating a method, implemented by the VAL server 100, for managing mapping of the VAL service area ID and the geographical area in the wireless network 1000, according to an s as disclosed herein. The operations or steps 1302 to 1304 are handled by the VAL service area controller 240.

At step 1302, the VAL server 100 may configure the VAL service area ID based on the VAL service area. At step 1304, the VAL server 100 may register the mapping of the VAL service area ID with the geographical area to the SEAL server 200.

FIG. 14 is a flow chart 1400 illustrating a method, implemented by the SEAL server 200, for managing mapping of the VAL service area ID and the geographical area in the wireless network 1000, according to the embodiments as disclosed herein. The operations or steps 1402 to 1404 are handled by the VAL service area controller 240.

At step 1402, the SEAL server may receive mapping of the VAL service area ID with the geographical area from the VAL server. At step 1404, the SEAL server may store the mapping of the at least one VAL service area ID with the geographical area in the memory 230.

Ease of use for VAL server users to work with the SEAL server (200) in relation with its Service Area. In an example, the VAL server administrator registers one time the service area-geographical co-ordinates mapping and let all other users of various SEAL services to seamlessly communicate with the service area identifier. By this way, even the change in the service area is one time notified by the VAL server administrator and automatically it will be affected without change in any of the APIs of both VAL server 100 and the SEAL server 200. The dynamic UE groupings in the SEAL GM based on the VAL service area without a single change of the application level in the VAL and SEAL GM work seamlessly even if the service area changes and even when the UEs dynamically move in and out, added and removed. This also enables VAL Service Provider to message all of the UEs in the particular service area in case of any emergency or notification of changes in billing or service changes. This will empower consumers as VAL Service users to pass on any actions or information very easily to all the members of the group.

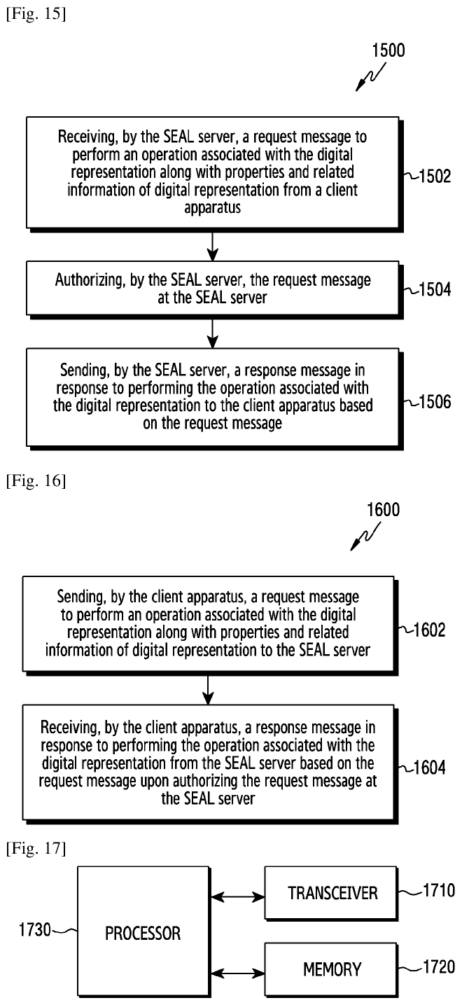

FIG. 15 is a flow chart 1500 illustrating a method, implemented by the SEAL server 200, for managing the digital representation in the wireless network (1000), according to the embodiments as disclosed herein. The operations or steps 1502 to 1506 are handled by the digital representation controller 250.

At step 1502, the method includes receiving the request message to perform the operation associated with the digital representation along with properties and related information of digital representation from the client apparatus (1200). At step 1504, the method includes authorizing the request message at the SEAL server. At step 1506, the method includes sending the response message in response to performing the operation associated with the digital representation to the client apparatus (1200) based on the request message.

FIG. 16 is a flow chart 1600 illustrating a method, implemented by the client apparatus 1200, for managing the digital representation in the wireless network 1000, according to an embodiment. The operations or steps 1602 to 1604 are handled by the digital representation controller (240).

At step 1602, the method includes sending the request message to perform the operation associated with the digital representation along with properties and related information of digital representation to the SEAL server 200. At step 1604, the method includes receiving the response message in response to performing the operation associated with the digital representation from the SEAL server 200 based on the request message upon authorizing the request message at the SEAL server 200.

A method performed by a vertical application layer (VAL) server in a wireless communication system is provided. The method comprises transmitting, to a location management server, a user equipment (UE) information request message including a first VAL service area identity (ID) of a first VAL service area and receiving, from the location management server, UE information as a response to the UE information request message. The UE information includes a list of at least one UE whose location is within an application defined proximity range of the first VAL service area corresponding to the first VAL service area ID, and the application defined proximity range includes a range in which the UE information is required.

The method comprises transmitting, to the location management server, a location area monitoring subscription request message to subscribe a list of UEs moving in or moving out of a second VAL service area corresponding to a second VAL service area ID included in the location area monitoring subscription request message and receiving, from the location management server, a monitoring subscription response message as a response to the monitoring subscription request message, the monitoring subscription response message including subscription status.

The method comprises transmitting, to the location management server, first information on a first list of at least one VAL service area ID and geographical information corresponding to the at least one VAL service area ID via an application programing interface (API) for configuring a VAL service area ID and receiving, from the location management server, second information as a response to the first information, the second information including a second list of at least one VAL service area ID via the API.

A creation of a location-based group is based on the first VAL service area corresponding to the first VAL service area ID.

A vertical application layer (VAL) server in a wireless communication system is provided. The VAL server comprises a transceiver and a controller coupled with the transceiver and configured to transmit, to a location management server, a user equipment (UE) information request message including a first VAL service area identity (ID) of a first VAL service area, and receive, from the location management server, UE information as a response to the UE information request message. The UE information includes a list of at least one UE whose location is within an application defined proximity range of the first VAL service area corresponding to the first VAL service area ID, and the application defined proximity range includes a range in which the UE information is required.

The controller is further configured to transmit, to the location management server, a location area monitoring subscription request message to subscribe a list of UEs moving in or moving out of a second VAL service area corresponding to a second VAL service area ID included in the location area monitoring subscription request message, and receive, from the location management server, a monitoring subscription response message as a response to the monitoring subscription request message, the monitoring subscription response message including subscription status.

The controller is further configured to transmit, to the location management server, first information on a first list of at least one VAL service area ID and geographical information corresponding to the at least one VAL service area ID via an application programing interface (API) for configuring a VAL service area ID, and receive, from the location management server, second information as a response to the first information, the second information including a second list of at least one VAL service area ID via the API.

A creation of a location-based group is based on the first VAL service area corresponding to the first VAL service area ID.

A method performed by a location management server in a wireless communication system is provided. The method comprises receiving, from a vertical application layer (VAL) server, a user equipment (UE) information request message including a first VAL service area identity (ID) of a first VAL service area; and transmitting, to the location management server, UE information as a response to the UE information request message. The UE information includes a list of at least one UE whose location is within an application defined proximity range of the first VAL service area corresponding to the first VAL service area ID, and the application defined proximity range includes a range in which the UE information is required.

The method comprises receiving, from the VAL server, a location area monitoring subscription request message to subscribe a list of UEs moving in or moving out of a second VAL service area corresponding to a second VAL service area ID included in the location area monitoring subscription request message and transmitting, to the VAL server, a monitoring subscription response message as a response to the monitoring subscription request message, the monitoring subscription response message including subscription status.

The method further comprises receiving, from the VAL server, first information on a first list of at least one VAL service area ID and geographical information corresponding to the at least one VAL service area ID via an application programing interface (API) for configuring a VAL service area ID and transmitting, to the VAL server, second information as a response to the first information, the second information including a second list of at least one VAL service area ID via the API.

A creation of a location-based group is based on the first VAL service area corresponding to the first VAL service area ID.

A location management server in a wireless communication system is provided. The location management server comprises a transceiver and a controller coupled with the transceiver and configured to receive, from a vertical application layer (VAL) server, a user equipment (UE) information request message including a first VAL service area identity (ID) of a first VAL service area, and transmit, to the location management server, UE information as a response to the UE information request message. The UE information includes a list of at least one UE whose location is within an application defined proximity range of the first VAL service area corresponding to the first VAL service area ID, and the application defined proximity range includes a range in which the UE information is required.

The controller is further configured to receive, from the VAL server, a location area monitoring subscription request message to subscribe a list of UEs moving in or moving out of a second VAL service area corresponding to a second VAL service area ID included in the location area monitoring subscription request message and transmit, to the VAL server, a monitoring subscription response message as a response to the monitoring subscription request message. The monitoring subscription response message includes subscription status.

The controller is further configured to receive, from the VAL server, first information on a first list of at least one VAL service area ID and geographical information corresponding to the at least one VAL service area ID via an application programing interface (API) for configuring a VAL service area ID, and transmit, to the VAL server, second information as a response to the first information, the second information including a second list of at least one VAL service area ID via the API. A creation of a location-based group is based on the first VAL service area corresponding to the first VAL service area ID.

A method for managing mapping of a Vertical Application Layer (VAL) service area identifier (ID) and a geographical area in a wireless network (1000) is provided. The method comprises configuring, by a VAL server (100), at least one VAL service area identifier (ID) based on a VAL service area and registering, by the VAL server (100), a mapping of the at least one VAL service area ID with a geographical area to a Service Enabling Architecture Layer (SEAL) server (200).

The method comprises performing, by the VAL server (100), at least one of: creating mapping of the VAL service area ID and the geographical area, modifying mapping of the geographical area associated with the VAL service area ID, updating mapping of the VAL service area ID and the geographical area, and deleting mapping of the VAL service area ID and the geographical area.

The mapping of the VAL service area ID with the geographical area is registered through a configuration information, wherein the SEAL server (200) propagates the mapping of the VAL service area ID and the geographical area associated with the VAL service area ID to all other SEAL server (200) s in a SEAL domain.

The method comprises sending, by the VAL server (100), a get UE information request to the SEAL server (200), wherein the get UE information request comprises the VAL service area ID, wherein the SEAL server (200) determines that location area associated with at least one User Equipment (UE) is within an application defined proximity range of the location information and receiving, by the VAL server (100), a get UE information response from the SEAL server (200) based on the get UE information request, wherein the get UE information response comprises a list of UEs and a location information corresponding to the list of UEs residing in the geographical area represented by the VAL service area ID.

The method comprises sending, by the VAL server (100), a location area monitoring subscription request to the SEAL server (200) to subscribe to a list of UEs moving in or moving out of a location area, wherein the location area monitoring subscription request includes the VAL service area ID denoting a geographical location information and receiving, by the VAL server (100), a location area monitoring subscription response from the SEAL server (200) based on the location area monitoring subscription request in response to the SEAL server (200) determines that the VAL server (100) is authorized to initiate the location area monitoring subscription request.

The method comprises sending, by the VAL server (100), a location based group creation request comprising the VAL service ID to a first SEAL server (200) and receiving, by the VAL server (100), a location based group creation response message from the first SEAL server (200) based on the location based group creation request.

The location based group creation response message is created by requesting, by the first SEAL server (200), to obtain at least one UE corresponding to location information to a second SEAL server (200), wherein the second SEAL server (200) generates a list of UEs within the requested location represented by the VAL service area ID and shares with the list of UEs within the requested location represented by the VAL service area ID to the first SEAL server (200), receiving, by the first SEAL server (200), the list of UEs within the requested location represented by the VAL service area ID from the second SEAL server (200) and creating and storing, by the first SEAL server (200), information of a location-based group during a group creation, wherein the first SEAL server (200) is a group management server (200b) and the second SEAL server (200) is a location management server (200a).

A method for managing mapping of a VAL service area ID and a geographical area in a wireless network (1000) is provide. The method comprises receiving, by a SEAL server (200), mapping of at least one VAL service area ID with a geographical area from a VAL server (100) and storing, by the SEAL server (200), the mapping of the at least one VAL service area ID with the geographical area.

The method comprises performing, by the SEAL server (200), at least one of: creating mapping of the VAL service area ID and the geographical area, modifying mapping of the VAL service area ID and the geographical area, updating mapping of the VAL service area ID and the geographical area, and deleting mapping of the VAL service area ID and the geographical area upon detecting a change in a VAL service area.

The mapping of the VAL service area ID and the geographical area associated with the VAL service area ID is registered through a configuration information, wherein the SEAL server (200) propagates the mapping of the VAL service area ID and a geographical area associated with the VAL service area ID to all other SEAL servers in a SEAL domain.

The method comprises receiving, by the SEAL server (200), a get UE information request from a VAL SEAL server (200), wherein the get UE information request comprises the VAL service area ID and an application defined proximity range, determining, by the SEAL server (200), that location area associated with the VAL service area ID and sending, by the SEAL server (200), a get UE information response to the VAL server (100) based on the get UE information request, wherein the get UE information response comprises a list of UEs residing in the geographical and a location information corresponding to the list of UEs.

The method comprises receiving, by the SEAL server (200), a location area monitoring subscription request from the VAL server (100) to subscribe to a list of UEs moving in or moving out of a specific location area, wherein the location area monitoring subscription request includes at least one of an identify of at least one of the VAL server (100), a VAL UE, and the SEAL server (200), a location information criteria comprising at least one of a geographic location information, the VAL service area ID denoting a geographical location information, and a reference UE along with an application defined proximity range from a reference UE, an time interval between consecutive reports, an immediate report indicator and at least one triggering event, determining, by the SEAL server (200), that the VAL server (100) is authorized to initiate the location area monitoring subscription request and sending, by the SEAL server (200), a location area monitoring subscription response to the VAL server (100) based on the location area monitoring subscription request.

The method comprises receiving, by a first SEAL server (200), a location based group creation request including a VAL service ID from a VAL server (100) and sending, by the first SEAL server (200), a location based group creation response message to the VAL server (100) based on the location based group creation request.

The location based group creation response message is created by requesting, by the first SEAL server (200), to obtain at least one UE corresponding to location information to a second SEAL server (200), wherein the second SEAL server (200) generates a list of UEs within the requested location and shares with the list of UEs within the requested location to the first SEAL server (200), receiving, by the first SEAL server (200), the list of UEs within the requested location from the second SEAL server (200) and creating and storing, by the first SEAL server (200), information of a location-based group during a group creation, wherein the first SEAL server (200) is a group management server (200b) and the second SEAL server (200) is a location management server (200a).

A method for managing a digital representation in a wireless network (1000) is provided. The method comprises sending, by a client apparatus, a request message to perform at least one operation associated with the digital representation along with properties and related information of digital representation to a SEAL server (200) and receiving, by the client apparatus, a response message in response to performing the operation associated with the digital representation from the SEAL server (200) based on the request message upon authorizing the request message at the SEAL server (200).

The at least one operation comprises a create operation, a get operation, a modification operation and a delete operation, wherein the digital representation comprises at least one of: an avatar, alter egos, digital assets and a digital wallet, wherein the properties and related information of the digital representation comprises at least one of an avatar identity, user list, current status, shape, size, color, virtual position, access speed, location history, and an application history.

The Avatar ID is used to uniquely identify the avatar or the alter egos or the digital representation, wherein the user list comprises a list of one or more user's identity who are allowed to use the Avatar, wherein the current status indicates whether the avatar is currently in use or not, wherein the allowed application list specifies the list of the application identifiers for which the Avatar is used, wherein the allowed location specifies the location range or the area of the user whether the Avatar is used, wherein the one or more predictive model specifies the model used to train the Avatar, wherein the life time indicates the time since the Avatar is created and registered, wherein the expiry time indicates the time till when the Avatar is used by the user, wherein the wallet list specifies the identity associated with user's finance source which allows the user to purchase items in the metaverse using the avatar, wherein the access rights, the authentication information and the security tokens are used to provide secure access of the Avatar and its related information to the user.

The request message comprises at least one of an digital representation identifier (ID), at least one operation and parameters, wherein the parameters comprise at least one of: an avatar identity, a user list, current status, shape, size, color, virtual position, access right, authentication information, a security token, allowed application list, allowed location, wallet list, a predictive model, life time, an input technique, expiry time, speed, location history, and an application history.

The client apparatus is communicated with the SEAL server (200) over an interface-1, wherein the interface-1 supports at least one of a unicast delivery mode and a multicast delivery mode.

A method for managing a digital representation in a wireless network (1000) is provided. The method comprises receiving, by a SEAL server (200), a request message to perform at least one operation associated with the digital representation along with properties and related information of digital representation from a client apparatus, authorizing, by the SEAL server (200), the request message at the SEAL server (200) and sending, by the SEAL server (200), a response message in response to performing the operation associated with the digital representation to the client apparatus based on the request message.

The at least one operation comprises a create operation, a get operation, a modification operation and a delete operation, wherein the digital representation comprises at least one of: an avatar, alter egos, digital assets and digital wallet, wherein the properties and related information of the digital representation comprises at least one of an avatar identity, user list, current status, shape, size, color, virtual position, access speed, location history, and an application history.

The request message comprises at least one of an digital representation identifier (ID), at least one operation and parameters, wherein the parameters comprise at least one of a user list, current status, shape, size, color, virtual position, access right, authentication information, a security token, allowed application list, allowed location, wallet list, a predictive model, an input method, life time, expiry time, speed, location history, and an application history.

The client apparatus is communicated with the SEAL server (200) over an interface-1, wherein the interface-1 supports a unicast delivery mode and a multicast delivery mode.

A wireless network (1000) comprising a first client apparatus and a first SEAL server (200). The first SEAL server (200) is configured to receive a request message to perform at least one operation associated with the digital representation along with properties and related information of digital representation from the first client apparatus, authorize the request message at the first SEAL server (200) and send a response message in response to performing the operation associated with the digital representation to the first client apparatus based on the request message.

The wireless network (1000) comprises a second client apparatus, a second server and a 3rd Generation Partnership Project (3GPP) network wherein the first client apparatus is communicated with the first SEAL server (200) over an interface-1, wherein the interface-1 supports a unicast delivery mode and a multicast delivery mode, wherein the second client apparatus is communicated with the second server over an interface-4, wherein the first client apparatus is communicated with the second client apparatus over an interface-5, wherein the first SEAL server (200) is communicated with the second server over an interface-2 and wherein the 3GPP network is communicated with the first SEAL server (200) over an interface-3.

The first client apparatus provides a service enabler layer support function for managing along with the properties and related information of the digital representation to the second client apparatus over an interface-5; and the first SEAL server (200) for managing the digital representation to an application function.

The at least one operation comprises a create operation, a get operation, a modification operation and a delete operation, wherein the digital representation comprises at least one of: an avatar, alter egos, digital assets, and digital wallet, wherein the request message comprises at least one of an digital representation identifier (ID), at least one operation and parameters, wherein the parameters comprise at least one of an avatar identity, a user list, current status, shape, size, color, virtual position, access location, wallet list, a predictive model, an input method, life time, expiry time, speed, location history, and an application history.

A VAL server (100) comprises a processor (110) a memory (130) and a VAL service area controller (140), coupled with the processor (110) and the memory (130), configured to configure at least one VAL service area ID based on a VAL service area and register a mapping of the at least one VAL service area ID with a geographical area to a SEAL server (200).

A SEAL server (200) comprises a processor (210), a memory (230); and a VAL service area controller (240), coupled with the processor (210) and the memory (230), configured to receive mapping of at least one VAL service area ID with a geographical area from a VAL server (100) and store mapping of the at least one VAL service area ID with the geographical area.

A client apparatus (1200) comprises a processor (1210), a memory (1230) and a digital representation controller (1240), coupled with the processor (1210) and the memory (1230), configured to send a request message to perform at least one operation associated with the digital representation along with properties and related information of digital representation to a SEAL server (200) and receive a response message in response to performing the operation associated with the digital representation from the SEAL server (200) based on the request message upon authorizing the request message at the SEAL server (200).

A SEAL server (200), comprises a processor (210), a memory (230); and a digital representation controller (250), coupled with the processor (210) and the memory (230), configured to receive a request message to perform at least one operation associated with the digital representation along with properties and related information of digital representation from a client apparatus, authorize the request message at the SEAL server (200) and send a response message in response to performing the operation associated with the digital representation to the client apparatus based on the request message.

FIG. 17 illustrates a structure of a UE according to an embodiment of the disclosure.

As shown in FIG. 17, the UE according to an embodiment may include a transceiver 1710, a memory 1720, and a processor 1730. The transceiver 1710, the memory 1720, and the processor 1730 of the UE may operate according to a communication method of the UE described above. However, the components of the UE are not limited thereto. For example, the UE may include more or fewer components than those described above. In addition, the processor 1730, the transceiver 1710, and the memory 1720 may be implemented as a single chip. Also, the processor 1730 may include at least one processor. Furthermore, the UE of FIG. 17 corresponds to the UE of FIG. 1.

The transceiver 1710 collectively refers to a UE receiver and a UE transmitter, and may transmit/receive a signal to/from a base station or a network entity. The signal transmitted or received to or from the base station or a network entity may include control information and data. The transceiver 1710 may include a RF transmitter for up-converting and amplifying a frequency of a transmitted signal, and a RF receiver for amplifying low-noise and down-converting a frequency of a received signal. However, this is only an example of the transceiver 1710 and components of the transceiver 1710 are not limited to the RF transmitter and the RF receiver.

Also, the transceiver 1710 may receive and output, to the processor 1730, a signal through a wireless channel, and transmit a signal output from the processor 1730 through the wireless channel.

The memory 1720 may store a program and data required for operations of the UE. Also, the memory 1720 may store control information or data included in a signal obtained by the UE. The memory 1720 may be a storage medium, such as read-only memory (ROM), random access memory (RAM), a hard disk, a CD-ROM, and a DVD, or a combination of storage media.

The processor 1730 may control a series of processes such that the UE operates as described above. For example, the transceiver 1710 may receive a data signal including a control signal transmitted by the base station or the network entity, and the processor 1730 may determine a result of receiving the control signal and the data signal transmitted by the base station or the network entity.

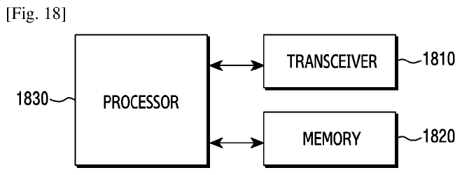

FIG. 18 is a block diagram showing an internal structure of a network entity, according to an embodiment of the present disclosure. As shown in FIG. 18, the network entity of the present disclosure may include a transceiver 1810, a memory 1820, and a processor 1830. The transceiver 1810, the memory 1820, and the processor 1830 of the network entity may operate according to a communication method of the network entity described above. However, the components of the terminal are not limited thereto. For example, the network entity may include more or fewer components than those described above. In addition, the processor 1830, the transceiver 1810, and the memory 1820 may be implemented as a single chip. Also, the processor 1830 may include at least one processor. Furthermore, the network entity of FIG. 9 corresponds to the VAL server 100 and/or the SEAL server 200 of the FIG. 1, the location management server 200a of FIG. 2, the group management client and/or the group management server 200b of FIG. 4, 5GC 300 and/or NRM server 200c of FIG. 6.

The transceiver 1810 collectively refers to a network entity receiver and a network entity transmitter, and may transmit/receive a signal to/from a base station or a UE. The signal transmitted or received to or from the base station or the UE may include control information and data. In this regard, the transceiver 1810 may include a RF transmitter for up-converting and amplifying a frequency of a transmitted signal, and a RF receiver for amplifying low-noise and down-converting a frequency of a received signal. However, this is only an example of the transceiver 1810 and components of the transceiver 1810 are not limited to the RF transmitter and the RF receiver.

Also, the transceiver 1810 may receive and output, to the processor 1830, a signal through a wireless channel, and transmit a signal output from the processor 1830 through the wireless channel.

The memory 1820 may store a program and data required for operations of the network entity. Also, the memory 1820 may store control information or data included in a signal obtained by the network entity. The memory 1820 may be a storage medium, such as ROM, RAM, a hard disk, a CD-ROM, and a DVD, or a combination of storage media.

The processor 1830 may control a series of processes such that the network entity operates as described above. For example, the transceiver 1810 may receive a data signal including a control signal, and the processor 1830 may determine a result of receiving the data signal.

Embodiments herein disclose methods and wireless network for including a VAL service area as a location identification attribute in SEAL server in the network (1000) by VAL server (100), where a location attribute (e.g., VAL service area), which refers to a geographical area served by a particular VAL server, and making an attribute a part of the location attribute which can be associated with a UE along with the existing location attributes (e.g., like Latitude/Longitude, etc., hereby enabling seamless automatic efficient service delivery for multiple VAL SPs to the consumers using a SEAL server. In an embodiment, the method includes configuring a VAL service area ID based on a VAL service area. Further, the method includes registering a mapping of the VAL service area ID with a geographical area to the SEAL server. Also, the method can be used to manage a digital representation in a wireless network.

The various actions, acts, blocks, steps, or the like in the flow charts (1300 to 1600) may be performed in the order presented, in a different order or simultaneously. Further, in some embodiments, some of the actions, acts, blocks, steps, or the like may be omitted, added, modified, skipped, or the like without departing from the scope of the invention.

The embodiments disclosed herein can be implemented through at least one software program running on at least one hardware device and performing network management functions to control the elements. The elements can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the spirit and scope of the embodiments as described herein.

1. A method performed by a vertical application layer (VAL) server in a wireless communication system, the method comprising:
transmitting, to a location management server, a user equipment (UE) information request message including a first VAL service area identity (ID) of a first VAL service area; and
receiving, from the location management server, UE information as a response to the UE information request message,
wherein the UE information includes a list of at least one UE whose location is within an application defined proximity range of the first VAL service area corresponding to the first VAL service area ID, and
wherein the application defined proximity range includes a range in which the UE information is required.

2. The method of claim 1, further comprising:
transmitting, to the location management server, a location area monitoring subscription request message to subscribe a list of UEs moving in or moving out of a second VAL service area corresponding to a second VAL service area ID included in the location area monitoring subscription request message; and
receiving, from the location management server, a monitoring subscription response message as a response to the monitoring subscription request message, the monitoring subscription response message including subscription status.

3. The method of claim 1, further comprising:
transmitting, to the location management server, first information on a first list of at least one VAL service area ID and geographical information corresponding to the at least one VAL service area ID via an application programing interface (API) for configuring a VAL service area ID; and
receiving, from the location management server, second information as a response to the first information, the second information including a second list of at least one VAL service area ID via the API.

4. The method of claim 1, wherein a creation of a location-based group is based on the first VAL service area corresponding to the first VAL service area ID.

5. A vertical application layer (VAL) server in a wireless communication system, the method comprising:
a transceiver; and
a controller coupled with the transceiver and configured to;
transmit, to a location management server, a user equipment (UE) information request message including a first VAL service area identity (ID) of a first VAL service area, and
receive, from the location management server, UE information as a response to the UE information request message,
wherein the UE information includes a list of at least one UE whose location is within an application defined proximity range of the first VAL service area corresponding to the first VAL service area ID, and
wherein the application defined proximity range includes a range in which the UE information is required.

6. The VAL server of claim 5, wherein the controller is further configured to:
transmit, to the location management server, a location area monitoring subscription request message to subscribe a list of UEs moving in or moving out of a second VAL service area corresponding to a second VAL service area ID included in the location area monitoring subscription request message, and
receive, from the location management server, a monitoring subscription response message as a response to the monitoring subscription request message, the monitoring subscription response message including subscription status.

7. The VAL server of claim 5, wherein the controller is further configured to:
transmit, to the location management server, first information on a first list of at least one VAL service area ID and geographical information corresponding to the at least one VAL service area ID via an application programing interface (API) for configuring a VAL service area ID, and
receive, from the location management server, second information as a response to the first information, the second information including a second list of at least one VAL service area ID via the API.

8. The VAL server of claim 5, wherein a creation of a location-based group is based on the first VAL service area corresponding to the first VAL service area ID.

9. A method performed by a location management server in a wireless communication system, the method comprising:
receiving, from a vertical application layer (VAL) server, a user equipment (UE) information request message including a first VAL service area identity (ID) of a first VAL service area; and
transmitting, to the location management server, UE information as a response to the UE information request message,
wherein the UE information includes a list of at least one UE whose location is within an application defined proximity range of the first VAL service area corresponding to the first VAL service area ID, and
wherein the application defined proximity range includes a range in which the UE information is required.

10. The method of claim 9, further comprising:
receiving, from the VAL server, a location area monitoring subscription request message to subscribe a list of UEs moving in or moving out of a second VAL service area corresponding to a second VAL service area ID included in the location area monitoring subscription request message; and
transmitting, to the VAL server, a monitoring subscription response message as a response to the monitoring subscription request message,
the monitoring subscription response message including subscription status.

11. The method of claim 9, further comprising:
receiving, from the VAL server, first information on a first list of at least one VAL service area ID and geographical information corresponding to the at least one VAL service area ID via an application programing interface (API) for configuring a VAL service area ID; and
transmitting, to the VAL server, second information as a response to the first information, the second information including a second list of at least one VAL service area ID via the API.

12. The method of claim 9, wherein a creation of a location-based group is based on the first VAL service area corresponding to the first VAL service area ID.

13. A location management server in a wireless communication system, the location management server comprising:
a transceiver; and
a controller coupled with the transceiver and configured to:
receive, from a vertical application layer (VAL) server, a user equipment (UE) information request message including a first VAL service area identity (ID) of a first VAL service area, and
transmit, to the location management server, UE information as a response to the UE information request message,
wherein the UE information includes a list of at least one UE whose location is within an application defined proximity range of the first VAL service area corresponding to the first VAL service area ID, and
wherein the application defined proximity range includes a range in which the UE information is required.

14. The location management server of claim 13, wherein the controller is further configured to:
receive, from the VAL server, a location area monitoring subscription request message to subscribe a list of UEs moving in or moving out of a second VAL service area corresponding to a second VAL service area ID included in the location area monitoring subscription request message; and
transmit, to the VAL server, a monitoring subscription response message as a response to the monitoring subscription request message,
wherein the monitoring subscription response message includes subscription status.

15. The location management server of claim 13, wherein the controller is further configured to:
receive, from the VAL server, first information on a first list of at least one VAL service area ID and geographical information corresponding to the at least one VAL service area ID via an application programing interface (API) for configuring a VAL service area ID, and
transmit, to the VAL server, second information as a response to the first information, the second information including a second list of at least one VAL service area ID via the API, and
wherein a creation of a location-based group is based on the first VAL service area corresponding to the first VAL service area ID.
